(19) United States
(12) Patent Application Publication
(10) Pub. No.: US 2004/0183915 A1
(43) Pub. Date: Sep. 23, 2004

(54) Method, device, and program for controlling imaging device

(76) Inventors: Yukita Gotohda, Kanagawa-ken (JP); Hajime Shirasaka, Kanagawa-ken (JP); Jun Enomoto, Kanagawa-ken (JP); Hiroshi Yamaguchi, Kanagawa-ken (JP)

Correspondence Address: BIRCH STEWART KOLASCH & BIRCH, PO BOX 747, FALLS CHURCH, VA, 22040-0747, US

(21) Appl. No.: 10/649,824

(22) Filed: Aug. 28, 2003

(30) Foreign Application Priority Data
Aug. 28, 2002 (JP) 249210/2002
Aug. 28, 2002 (JP) 249211/2002
Sep. 27, 2002 (JP) 283890/2002
Sep. 27, 2002 (JP) 283892/2002
Sep. 27, 2002 (JP) 283893/2002
Sep. 27, 2002 (JP) 283895/2002
Jul. 30, 2003 (JP) 282788/2003
Jul. 30, 2003 (JP) 282789/2003
Jul. 30, 2003 (JP) 282790/2003
Jul. 30, 2003 (JP) 282791/2003
Jul. 30, 2003 (JP) 282792/2003
Aug. 21, 2003 (JP) 297347/2003

(51) Int. Cl. H04N 5/225

(52) U.S. Cl. 348/207.11

(57) ABSTRACT

Users of digital cameras are ensured to photograph in a remote camera system which employs a plurality of imaging devices. One digital camera is set as a master camera, and other digital cameras are set as slave cameras. Thus, based on the photography operation of the master camera, the slave cameras photograph. By pressing a shutter button of the master camera halfway, photography notification data is sent to the slave cameras from the master camera, notifying that the photographing is about to take place. After receiving the notice, the slave cameras perform photography notification by outputting sound or voice, displaying messages, or the like. Therefore, the users of the slave cameras are able to know that photographing is about to take place.

### BACKGROUND OF THE INVENTION

1. Field of the Invention

The present invention relates to a method and a device for controlling an imaging device, which control the operation of imaging devices such as a plurality of cameras connected via a network, for example, a wireless LAN and store a plurality of image data acquired by a plurality of imaging devices, and to a program for causing a computer to execute the method for controlling an imaging device.

2. Description of the Related Art

Remote camera systems, in which images captured by cameras installed at distant places can be viewed via a network, have been proposed. These remote camera systems are not only able to merely view camera images, but also able to control the direction and zoom magnification of the cameras from distant places. Moreover, a method for controlling the operation of a plurality of cameras by one camera has been proposed for the remote camera systems (e.g., refer to Japanese Unexamined Patent Publication No. 2000-113166).

Incidentally, the foregoing remote camera systems can be applied to digital cameras. Specifically, in the case where a plurality of users own digital cameras individually, it is possible to make the digital cameras of other users photograph simultaneously or sequentially when one user photographs by use of the one user's own digital camera. By thus operating the plurality of associated digital cameras, one object can be photographed from different angles at the same time. Therefore, the users can enjoy photography even more.

Nevertheless, other users are not necessarily concentrating on photography when one user photographs an object. For example, the other users may not be directing their cameras toward the object or may be photographing other objects. In these cases, there is a possibility that the digital cameras of the other users cannot perform photography. Even if the digital cameras of the other users have performed photography, there will still be a possibility that totally different objects are photographed.

By collectively storing image data acquired by a plurality of cameras, it is possible to facilitate utilization of the image data, such as distribution and creation of photo albums.

However, since file names are attached to the image data in the order of photography in each camera, the file names may overlap when the image data acquired by the plurality of cameras are stored collectively. When the file names overlap, it is necessary for an operator to change the file names for storage. This is vexatious for the operator. Moreover, there is a possibility that image data overwrites other image data of the same file name, thereby erasing the other image data.

To distribute image data, e-mails, to which the image data are attached, are sent to cameras owned by people included in the image represented by the image data. Alternatively, e-mails, in which a URL indicating the storage location of the image data is written, are sent to the cameras. In this way, users who have received the image data can display images photographed by others on their own camera monitors and enjoy them.

Nevertheless, camera monitors have different resolutions, gradation characteristics, color reproduction characteristics, sizes, aspect ratios and the like depending on model. Thus, although image data acquired by one camera is displayed with high quality on that camera, the image data is not necessarily displayed with preferable quality when displayed on other cameras.

In the aforementioned remote camera systems, storage destinations of image data should be determined since the image data are acquired by each of the plurality of cameras. Otherwise, it is hard to know which camera has acquired the image data and where the image data is stored. As a result, it becomes difficult to find the image data when the image data is utilized for distribution and creation of photo albums.

Moreover, in the remote camera system, image data are acquired by each of the plurality of cameras. Accordingly, the image data acquired by each of the plurality of cameras are displayed on one of the cameras used in the remote camera system or a server which manages the image data. As disclosed in the aforementioned Japanese Unexamined Patent Publication No. 2000-113166, the image data acquired by individual cameras are usually displayed on a plurality of divided regions of a monitor.

However, this display method has a problem that it is impossible to know which camera has instructed other cameras to photograph by simply looking at a display window of the images. In addition, there is another problem that it is impossible to know which images belong to one's own camera by simply looking at the display window when images photographed by one's own camera and other cameras are displayed on a plurality of cameras.

Furthermore, to utilize the image data, the image data need to be arranged by, for example, sorting the image data according to photography date/time. The image data can be sorted based on photography date/time data attached to the image data. The photography date/time data represents photography time. However, since the remote camera system allows the plurality of digital cameras to acquire image data, clocks in the digital camera should be synchronized. Otherwise, when the image data are sorted according to photography date/time, the order of actual photography and the order of sorting will not agree.

### SUMMARY OF THE INVENTION

In consideration of the foregoing circumstances, a first object of the present invention is to ensure that a user of the imaging devices positively performs photography in a remote camera system which employs imaging devices such as a plurality of digital cameras.

A second object of the present invention is to collectively store and manage a plurality of image data acquired by a plurality of imaging devices without difficulties.

A third object of the present invention is to display a high quality image even when the image data are acquired by imaging devices of other users.

A fourth object of the present invention is to facilitate retrieval of stored image data.

A fifth object of the present invention is to facilitate recognition of images acquired by particular imaging devices.

A sixth object of the present invention is to display images acquired by each imaging device to see the distances between the object and each of the plurality of imaging devices.

A seventh object of the present invention is to make a photography time represented by photography date/time data attached to the image data agree with a photography time calculated based on a reference time serving as an actual photography time.

A first method for controlling an imaging device according to the present invention associates a plurality of imaging devices via a network to operate them. The method is characterized in that photography notification data for causing a desired imaging device among the plurality of imaging devices to perform photography notification is sent when causing the plurality of imaging devices to perform photography operations.

Examples of the imaging devices include digital cameras dedicated to photography which acquire digital image data by photographing objects. The digital image data represent the images of objects. The examples further include digital cameras installed in mobile terminal devices with communication functions, such as mobile phones or PDAs.

The photography notification data is able to notify users who own other imaging devices that photography is about to take place. Specifically, the photography notification data can cause other imaging devices to perform a variety of photography notifications including voice and sounds such as a beep and a chime. The photography notification data also includes character display on monitors of the imaging devices, changes in display colors and vibration. Note that the photography notification data may preferably include information for instructing photography angles and objects.

The desired imaging device may be all of the plurality of imaging devices or at least one imaging device selected from the plurality of imaging devices.

In the first method for controlling an imaging device according to the present invention, one of the plurality of imaging devices may send the photography notification data.

In this case, the photography notification data may be sent based on the photography operation of the one imaging device.

Specifically, the photography notification data is preferably sent by pressing a shutter butt on half way. However, the photography notification data may be also sent by providing a dedicated button on the one imaging device to send the photography notification data and pressing the button.

A first device for controlling an imaging device according to the present invention associates a plurality of imaging devices via a network to operate them. The first device comprises photography notification means for sending photography notification data for causing a desired imaging device among the plurality of imaging devices to perform photography notification when causing the plurality of imaging devices to perform photography operations.

Note that the first device for controlling an imaging device according to the present invention may be configured as being provided in one of the plurality of imaging devices.

In this case, the photography notification data may be sent based on the photography operation of the one imaging device.

Note that the first method for controlling an imaging device according to the present invention can be provided as a program for causing a computer to execute the method.

According to the first method and device for controlling an imaging device of the present invention, the photography notification data is sent to a desired imaging device among the plurality of imaging devices when causing the plurality of imaging devices to perform photography operations. Accordingly, by having the plurality of imaging devices perform photography notification based on the photography notification data, users of the imaging devices can know in advance that photography is about to take place. Thus, the users direct their imaging devices toward an object, for example. Therefore, it is possible to ensure that users of a plurality of imaging devices perform photography.

In addition, by sending the photography notification data from one of the plurality of imaging devices, it is possible to ensure that other imaging devices photograph an object which one imaging device is about to photograph.

Moreover, by sending the photography notification data based on the photography operation of the one imaging device, it is possible to notify the users of other imaging devices of the photography without special operations.

A second method for controlling an imaging device according to the present invention associates a plurality of imaging devices via a network to operate them and acquires image data by photographing with the plurality of imaging devices in one photography operation. The second method is characterized by collectively managing a plurality of imaging data acquired by the plurality of imaging devices.

In the second method for controlling an imaging device according to the present invention, different file names may be attached to the plurality of image data acquired by the plurality of imaging devices to collectively store the plurality of image data.

The different file names indicate file names which do not overlap among the plurality of image data. To be more specific, file names serially attached in the order of storage, file names with different symbols for each imaging device (e.g., Letter A is always attached to data acquired by an imaging device A), and the like can be used.

It is necessary to have different file names only when image data are stored. For example, different file names may be attached when the plurality of imaging devices acquire the image data. Alternatively, file names attached to the image data upon photography may be changed to different file names when the plurality of image data are stored.

In the second method for controlling an imaging device according to the present invention, a plurality of image data may be managed based on photography status information indicating a status of when each of the plurality of image data was photographed.

The photography status information indicates an imaging device and operation which acquire the image data. The photography status information includes information on a type of an imaging device and information on whether the image data was acquired by sequential or single operation.

Note that photography status information is preferably displayed with file names of image data when stored image data are listed.

Furthermore, in the second method for controlling an imaging device, the plurality of image data can be managed in one of the plurality of imaging devices.

A second device for controlling an imaging device according to the present invention associates a plurality of imaging devices via a network to operate them and acquires image data by photographing with the plurality of imaging devices in one photography operation. The second device comprises management means for collectively managing the plurality of image data acquired by the plurality of imaging devices.

In the second device for controlling an imaging device according to the present invention, the management means may further comprise storage means for collectively storing the plurality of image data acquired by the plurality of imaging devices by attaching a different file name to each of the plurality of image data.

In the second device for controlling an imaging device according to the present invention, the management means may manage the plurality of image data based on photography status information indicating the status of when each of the plurality of image data was photographed.

The second device for controlling an imaging device according to the present invention may be provided on one of the plurality of imaging devices.

Note that the second method for controlling an imaging device according to the present invention may be provided as a program for causing a computer to execute the second method.

According to the second method and device for controlling an imaging device of the present invention, image data acquired by a plurality of imaging devices are collectively managed. Accordingly, the image data acquired by each of the plurality of imaging devices are stored in the respective imaging devices. Thus, it is possible to manage the image data acquired by the plurality of imaging devices in management destinations without changing file names and overwriting the image data.

In addition, a different file name is attached to each of the image data acquired by the plurality of imaging devices to collectively store the image data. Hence, the file names will not overlap even when the image data are collectively stored. Moreover, it becomes unnecessary for an operator to change the file names when storing the image data. Further, it is possible to prevent the image data from being overwritten, so that the image data will not be erased.

Furthermore, the plurality of image data are managed based on photography status information indicating the status of when each of the plurality of image data was photographed. Accordingly, it is easy to know the imaging device and operation which acquired the image data, by referencing the photography status information.

The plurality of image data are managed in one of the plurality of imaging devices. Thus, the image data can be managed without particularly providing means such as a server for managing the image data.

A third method for controlling an imaging device according to the present invention associates a plurality of imaging devices via a network to operate them and acquires image data. The third method is characterized in that the image data are processed and displayed on display means in accordance with the display characteristics of the display means for displaying the image data.

The display characteristics of the display means include resolution, gradation characteristics, color reproduction characteristics, size, and an aspect ratio, which affect the quality of images to be displayed.

The process includes resolution conversion, gradation correction, color correction, density correction, enlargement, reduction, and trimming to suit the aspect ratio.

In the third method for controlling an imaging device according to the present invention, the processed image data may be displayed on one of the plurality of imaging devices.

In addition, the image data can be displayed by means such as a server for managing the image data acquired by the plurality of imaging devices. In this case, the display means is configured as being provided in the means such as a server.

In the third method for controlling an imaging device according to the present invention, the image data may be processed in each of the plurality of imaging devices.

To display the processed image data on one of the plurality of imaging devices, the image data are processed in one imaging device or each of the plurality of imaging devices.

In this case, whether to process the image data in the one imaging device or each of the plurality of imaging devices may be determined in accordance with the display characteristics of the display means of the plurality of imaging devices and/or communication capabilities of the plurality of imaging devices.

A third device for controlling an imaging device according to the present invention associates a plurality of imaging devices via a network to operate them and acquires image data. The third device comprises image processing means for processing the image data in accordance with the display characteristics of display means for displaying the image data.

In the third device for controlling an imaging device according to the present invention, the display means may be provided in one of the plurality of imaging devices.

Moreover, the third device for controlling an imaging device according to the present invention may be provided in each of the plurality of the imaging devices.

In the case where the display means is provided in one of the plurality of imaging devices and the device for controlling an imaging device according to the present invention is provided in each of the plurality of imaging devices, the third device further comprises control means for controlling the image processing means to process the image data in the one imaging device or in each of the plurality of imaging devices.

In this case, the control means may determine whether to process the image data in the one imaging device or in each of the plurality of imaging devices in accordance with the display characteristics of the display means of the plurality of imaging devices and/or communication capabilities of the plurality of imaging devices.

The third method for controlling an imaging device according to the present invention may be provided as a program for cuasing a computer to execute the third method.

According to the third method and device for controlling an imaging device of the present invention, the image data acquired by the plurality of imaging devices are processed in accordance with the display characteristics of the display means for displaying image data and displayed on the display means. Thus, it is possible to display high quality image data, which are processed in accordance with the display characteristics of the display means, on the display means.

By displaying the processed image data on one of the plurality of imaging devices, the image data acquired by other imaging devices can be displayed on the one imaging device with high quality.

By processing the image data in each of the plurality of imaging devices, it is possible to display the processed image data on the display means immediately after receiving the image data from the imaging devices. Therefore, the high quality images can be displayed quickly.

Moreover, the image data are processed in one imaging device or in each of the plurality of imaging devices. Accordingly, it is possible to remove a processing load of the imaging devices which do not process the image data.

In this case, whether to process the image data in one imaging device or each of the plurality of imaging devices is determined in accordance with the display characteristics and/or communication capabilities of the display means of the plurality of imaging devices. Thus, the image data can be processed properly in accordance with the display characteristics and/or communication capabilities of the display means of a particular imaging device.

A fourth method for controlling an imaging device according to the present invention associates a plurality of imaging devices via a network to operate them and acquires image data. The fourth method is characterized in that storage destination settings of the acquired image data are accepted in each of the plurality of imaging devices and that the image data acquired in each of the plurality of imaging devices are stored in the set storage destination.

A user's own imaging device, other imaging devices, a server for managing the image data or the like can be set as the storage destination. Furthermore, the image data can be stored in one storage destination or a plurality of storage destinations.

In the fourth method for controlling an imaging device according to the present invention, one of the plurality of imaging devices may be included as the storage destination.

Moreover, in the fourth method for controlling an imaging device according to the present invention, a change in the storage destination may be accepted when the image data cannot be stored in the storage destination.

The image data cannot be stored by the following reasons: the storage destination is physically broken; the storage destination is not working; the network is interrupted; or the available capacity of the storage destination is small or none. Thus, the image data cannot be stored although the image data are attempted to be stored in the storage destination.

A fourth device for controlling an imaging device according to the present invention associates a plurality of imaging devices via a network to operate them and acquires image data. The fourth device comprises setting means for accepting the storage destination settings of the acquired image data in each of the plurality of imaging devices, and storage means for storing the image data acquired by the plurality of imaging devices in the set storage destination. The fourth device is characterized in that the setting means and the storage means are provided in each of the plurality of imaging devices.

In the fourth device for controlling an imaging device according to the present invention, one of the plurality of imaging devices may be included as the storage destination.

Moreover, in the fourth device for controlling an imaging device according to the present invention, the setting means may accept a change in the storage destination when the image data cannot be stored in the storage destination.

Note that the forth method for controlling an imaging device according to the present invention may be provided as a program for causing a computer to execute the fourth method.

According to the fourth method and device for controlling an imaging device of the present invention, the storage destination settings of the acquired image data are accepted in each of the plurality of imaging devices. The image data acquired by each of the plurality of imaging devices are stored in the set storage destination. Consequently, it is possible to clarify the storage destination of the image data acquired by each of the plurality of imaging devices. Thus, to distribute image data later on or the like, the image data can be easily found. As a result, it is possible to facilitate the utilization of the image data after storage.

If one of the plurality of imaging devices is included as a storage destination, the image data acquired by the plurality of imaging devices are stored in the one imaging device. This facilitates the management of the image data in the imaging device.

When the image data cannot be stored in the storage destination, the change in the storage destination is accepted. Therefore, it is possible to avoid the situation where the image data cannot be stored.

A fifth method for controlling an imaging device according to the present invention associates a plurality of imaging devices via a network to operate them and acquires image data. The fifth method is characterized in that, when a plurality of images represented by the plurality of image data acquired by each of the plurality of imaging devices are displayed on one display means, an image represented by the image data acquired by a desired imaging device and images represented by the image data acquired by other imaging devices are displayed on the display means in different sizes.

A sixth method for controlling an imaging device according to the present invention associates a plurality of imaging devices via a network to operate them and acquires image data. The sixth method is characterized in that, when a plurality of images represented by the plurality of image data acquired by each of the plurality of imaging devices are displayed on one display means, the plurality of images are displayed on the display means in different sizes in accordance with distances between the plurality of imaging devices and an object.

The object refers to an object which is photographed or about to be photographed by the plurality of imaging devices simultaneously.

The plurality of images are displayed on the display means in different sizes in accordance with distances between the plurality of imaging devices and the object. For example, images represented by the image data acquired by the imaging devices at farther distances from the object are displayed in smaller sizes. Alternatively, images represented by the image data acquired by the imaging devices at farther distances from the object are displayed in larger sizes.

In the fifth and sixth methods for controlling an imaging device according to the present invention, an image selected from the plurality of displayed images may be enlarged to be displayed on the display means.

A fifth device for controlling an imaging device according to the present invention associates a plurality of imaging devices via a network to operate them and acquires image data. The fifth device comprises display control means for displaying an image represented by the image data acquired by a desired imaging device and images represented by the image data acquired by other imaging devices on one display means in different sizes when a plurality of images represented by the plurality of image data acquired by each of the plurality of imaging devices are displayed on the display means.

A sixth device for controlling an imaging device according to the present invention associates a plurality of imaging devices via a network to operate them and acquires image data. The sixth device comprises display control means for displaying the plurality of images on one display means in different sizes in accordance with distances between the plurality of imaging devices and an object when a plurality of images represented by the plurality of image data acquired by each of the plurality of imaging devices are displayed on the display means.

In the fifth and sixth devices for controlling an imaging device according to the present invention, the display control means may enlarge and display an image selected from the plurality of displayed images on the display means.

The fifth and sixth devices for controlling an imaging device according to the present invention can be provided in one of the plurality of imaging devices.

Note that the fifth and sixth methods for controlling an imaging device according to the present invention may be provided as programs for causing a computer to execute the fifth and sixth methods.

According to the fifth method and device for controlling an imaging device of the present invention, when a plurality of images represented by the plurality of image data acquired by each of the plurality of imaging devices are displayed on one display means, an image represented by the image data acquired by a desired imaging device and images represented by the image data acquired by other imaging devices are displayed on the display means in different sizes. Thus, it is easy to recognize the image acquired by the desired imaging device by simply looking at the plurality of images displayed on the display means.

According to the sixth method and device for controlling an imaging device of the present invention, when a plurality of images represented by the plurality of image data acquired by each of the plurality of imaging devices are displayed on one display means, the plurality of images are displayed on the display means in different sizes in accordance with distances between the plurality of imaging devices and an object. Thus, it is easy to recognize the distance between each imaging device and the object by simply looking at the sizes of the displayed images.

Moreover, it is possible to view details of an image selected from the plurality of displayed images by enlarging the selected image to be displayed on the display means.

A seventh method for controlling an imaging device according to the present invention associates a plurality of imaging devices, which comprise clocks and attach photography date/time data to image data acquired by photographing, via a network to operate them. The seventh method is characterized in that times indicated by the clocks of all the imaging devices are synchronized based on a predetermined time.

The predetermined time is a reference time for the plurality of imaging devices. For instance, a standard time or time indicated by the clock in one of the plurality of imaging devices can be used.

The time synchronization may be performed at each predetermined time or at certain time intervals. However, the time synchronization can be also performed based on the predetermined operation of one of the plurality of imaging devices.

The predetermined operation synchronizes time indicated by the clock of one imaging device, in which the operation is performed, with times indicated by the clocks of other imaging devices. An example of the predetermined operation includes a user of one imaging device manipulating a time synchronization button provided on the imaging device to transmit time synchronization signals to all the imaging devices via a network.

A seventh device for controlling an imaging device according to the present invention associates a plurality of imaging devices, which comprise clocks and attach photography date/time data to image data acquired by photographing, via a network to operate them. The seventh device comprises timer means for synchronizing times indicated by the clocks of all the imaging devices with a predetermined time.

In the seventh device for controlling an imaging device according to the present invention, the timer means may perform time synchronization based on a predetermined operation of one of the plurality of imaging devices.

The seventh device for controlling an imaging device according to the present invention may be provided in each of the plurality of imaging devices.

Note that the seventh method for controlling an imaging device according to the present invention can be provided as a program for causing a computer to execute the seventh method.

According to the seventh method and device for controlling an imaging device of the present invention, times of all the imaging devices are synchronized with the predetermined time. Accordingly, the photography time indicated by photography date/time data, attached to the image data acquired by each of the plurality of imaging devices, coincides with the photography time calculated with reference to the predetermined time. Thus, by arranging the image data based on the photography date/time data attached to the image data, the image data can be precisely sorted in the actual order of photography.

By synchronizing the times based on the predetermined operation of one of the plurality of imaging devices, it is possible to ensure that the photography time, indicated by the photography date/time data attached to the image data acquired by each of the plurality of imaging devices, and the photography time, calculated with reference to the predetermined time, agree with each other.

### BRIEF DESCRIPTION OF THE DRAWINGS

FIG. 1 is a block diagram schematically showing the structure of a remote camera system which employs a device for controlling an imaging device according to a first embodiment of the present invention.

FIG. 2 is a rear perspective view showing the configuration of a digital camera.

FIG. 3 is a diagram showing images displayed on a monitor.

FIG. 4 is a diagram showing a monitor screen which is divided in accordance with the number of the digital cameras.

FIGS. 5A and 5B are diagrams showing messages displayed on a monitor.

FIGS. 6A and 6B are diagrams for explaining the operation of manipulation commands.

FIG. 7 is a diagram showing standard messages.

FIG. 8 is a flow chart showing the process performed in the first embodiment.

FIGS. 9A and 9B are diagrams showing file names attached to image data in a second embodiment.

FIG. 10 is a diagram showing a file name management list.

FIG. 11 is a flow chart showing the process performed in the second embodiment.

FIG. 12 is a rear perspective view showing the configuration of a digital camera employed in a third embodiment.

FIG. 13 is a flow chart showing the process performed in the third embodiment.

FIG. 14 is a block diagram schematically showing another example of the remote camera system which employs a device for controlling an imaging device according to the third embodiment.

FIG. 15 is a block diagram schematically showing still another example of the remote camera system which employs a device for controlling an imaging device according to the third embodiment.

FIG. 16 is a diagram showing a storage destination selection menu used in a fourth embodiment.

FIG. 17 is a flow chart showing the process performed to set a storage destination in the fourth embodiment.

FIG. 18 is a flow chart showing the process performed to store image data in the fourth embodiment.

FIG. 19 is a flow chart showing the process performed to change the storage destinations in the fourth embodiment.

FIG. 20 is a rear perspective view showing the configuration of a digital camera used in a fifth embodiment.

FIG. 21 is a diagram showing images displayed on a monitor.

FIG. 22 is a diagram showing images displayed on a monitor.

FIG. 23 is a table showing a relationship between the number of display windows and window size.

FIGS. 24A to 24D are diagrams showing arrangements of the windows in accordance with the number of the display windows.

FIG. 25 is a diagram showing images displayed on a monitor.

FIG. 26 is a flow chart showing the process performed in a fifth embodiment.

FIG. 27 is a diagram showing an example of windows displayed on a monitor of a camera server in accordance with distances between the digital cameras and an object thereof.

FIG. 28 is a rear perspective view showing the configuration of a digital camera used in a sixth embodiment.

FIG. 29 is a flow chart showing the process performed for synchronization in the sixth embodiment.

FIG. 30 is a flow chart showing the process performed upon photographing in the sixth embodiment.

FIG. 31 is a diagram for explaining a peer-to-peer communication system.

### DESCRIPTION OF THE PREFERRED EMBODIMENTS

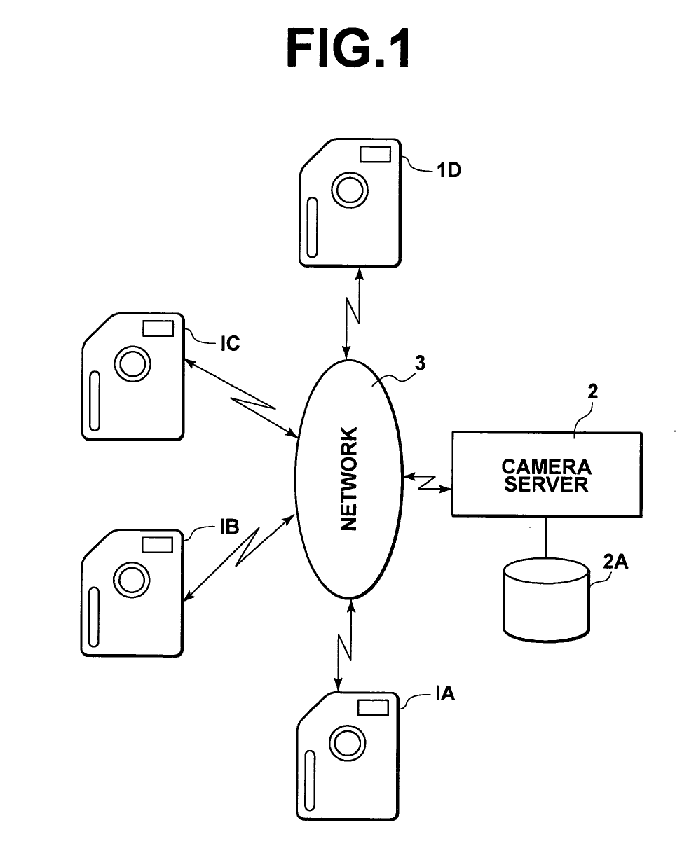

Embodiments of the present invention are described below with reference to the drawings. FIG. 1 is a block diagram schematically showing the structure of a remote camera system which employs a device for controlling an imaging device according to a first embodiment. As shown in FIG. 1, the remote camera system according to the first embodiment is structured by connecting a plurality of (four in this embodiment) digital cameras 1A to 1D and a camera server 2 via a network 3. Image data acquired by the digital cameras 1A to 1D are transmitted to the camera server 2, and the camera server 2 stores and manages the image data. Note that any network capable of remotely and mutually manipulating the digital cameras 1A to 1D can be used as the network 3 although a wireless LAN is used in the first embodiment.

In the first embodiment, the digital camera 1A is set as a master camera, and the digital cameras 1B to 1D are set as slave cameras. When the digital camera 1A photographs, the digital cameras 1B to 1D are controlled to photograph at the same time.

The digital camera 1A, set as the master camera, is able to photograph alone without making the digital cameras 1B to 1D photograph. In addition, the digital cameras 1B to 1D, set as the slave cameras, are able to photograph alone without receiving photography commands from the digital camera 1A. Herein, image data, which are acquired when each of the digital cameras 1A to 1D photographs alone, can be sent to the camera server 2 or stored in memory cards of the digital cameras 1A to 1D.

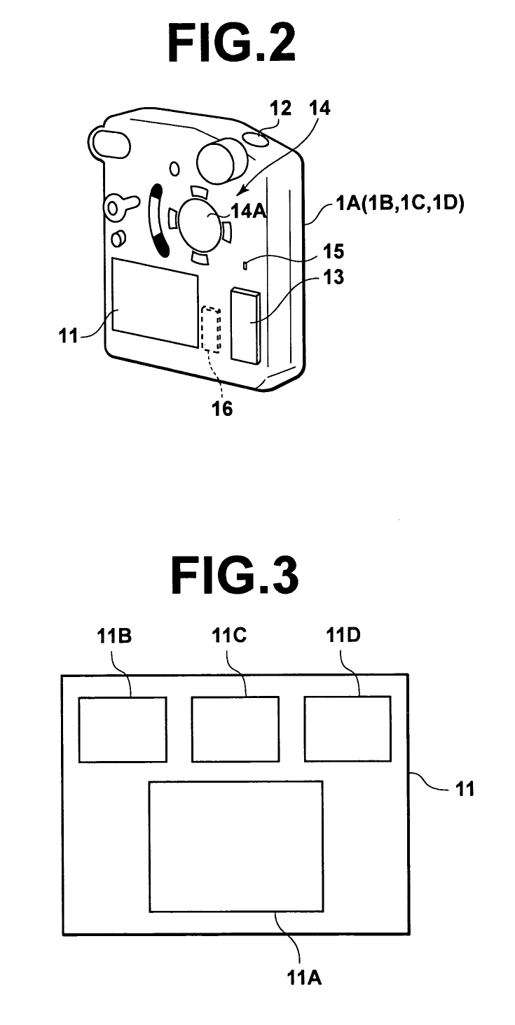

FIG. 2 is a rear perspective view showing the configuration of the digital camera 1A. Note that the digital cameras 1B to 1D have the same configuration as the digital camera 1A, and thus descriptions thereof are omitted. As shown in FIG. 2, the digital camera 1A comprises a monitor 11, a shutter button 12, a wireless LAN chip 13, input means 14 and a speaker 15. The monitor 11 displays a variety of images such as an image which is about to be photographed and a menu. The wireless LAN chip 13 performs communication by the wireless LAN. The input means 14 includes a cruciform key 14A which inputs various commands. The speaker 15 outputs sound. The interior of the digital camera 1A comprises photography notification means 16 which transmits photography notification data to the digital cameras 1B to 1D when the shutter button 12 is pressed halfway.

The monitor 11 displays both an image which the digital camera 1A itself is about to photograph and images which the digital cameras 1B to 1D are about to photograph. FIG. 3 is a view showing images displayed on the monitor 11. As shown in FIG. 3, the monitor 11 displays windows 11A to 11D. The window 11A displays an image which the digital camera 1A is about to photograph. The windows 11B to 11D display images which the digital cameras 1B to 1D are about to photograph, respectively. Since the window 11A displays an image which the digital camera 1A is about to photograph in FIG. 3, the window 11A is larger than the other windows 11B to 11D in size.

Since the windows 11B to 11D are smaller than the window 11A in size, the images displayed on the windows 11B to 11D may be difficult to see. Thus, the windows 11B to 11D may display only the central portions of the images which are about to be photographed. Alternatively, the windows 11B to 11D may be selected by the input means 14 to be enlarged and displayed on the monitor 11. The windows 11B to 11D normally display the entire images which are about to be photographed, but may display only the central portions of the images, which are about to be photographed, by the manipulation of the input means 14.

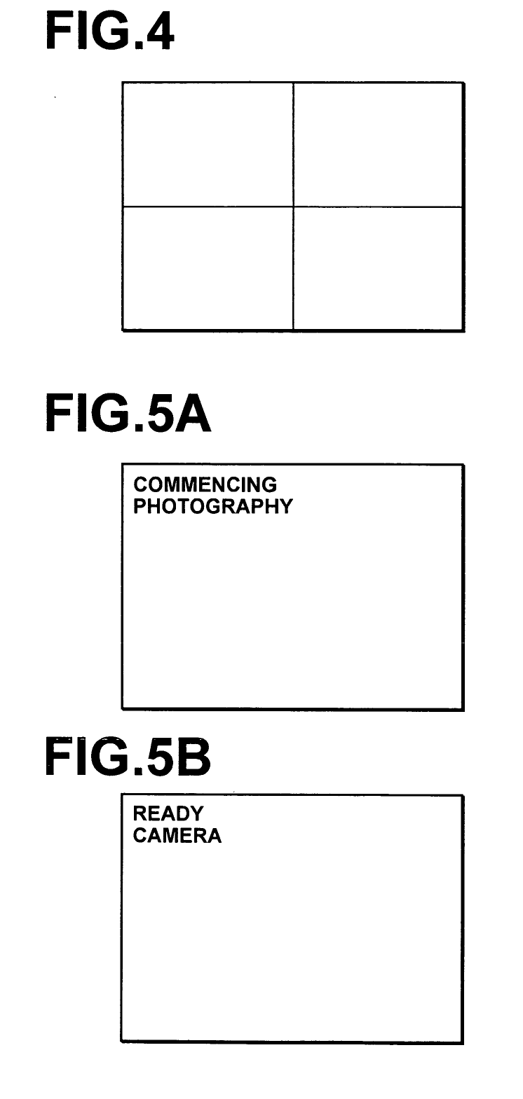

As shown in FIG. 4, the screen of the monitor 11 can be simply divided in accordance with the number of the digital cameras and display the images which the digital cameras 1A to 1D are about to photograph.

Note that the display control will be described in detail later in a fifth embodiment.

By being pressed halfway, the shutter button 12 focuses and performs photometry. By being pressed completely, the shutter button 12 drives a shutter to photograph. In the first embodiment, the half pressing of the shutter button 12 drives the photography notification means 16, and the photography notification data are transmitted to the digital cameras 1B to 1D from the wireless LAN chip 13 via the network 3. The photography notification data notifies the digital cameras 1B to 1D of that photograph is about to take place. The digital cameras 1B to 1D perform photography notification for users of the digital cameras 1B to 1D based on the photography notification data.

To be more specific, the photography notification is performed by outputting sound from the speakers 15 of the digital cameras 1B to 1D, such as a chime, a beep and voice including “commencing photography” and “ready camera.” As shown in FIGS. 5A and 5B, the monitors 11 of the digital cameras 1B to 1D may display messages such as “commencing-photography” and “ready camera” to perform the photography notification. The photography notification can be also performed by combining the messages and the voice. The photography notification can be further performed by blinking the monitors 11, reversing the display colors of the monitors 11, vibrating the cameras, or the like.

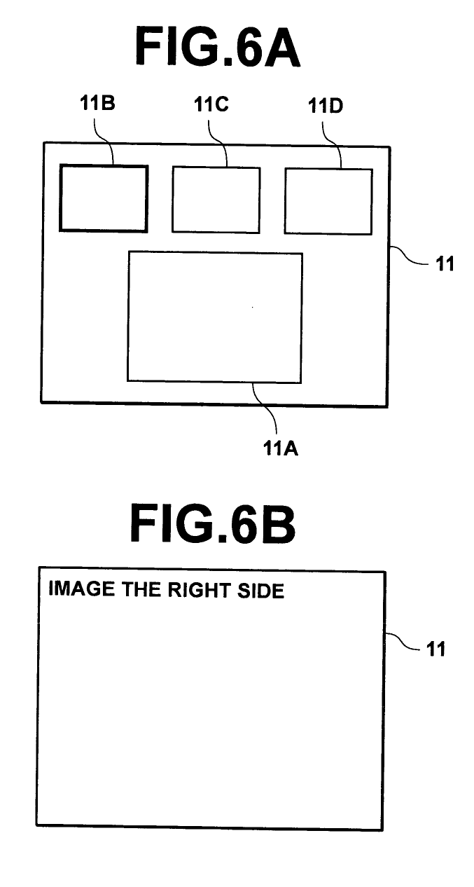

In addition, after sending the photography notification data, the monitors 11 of the digital cameras 1B to 1D may display the manipulation commands sent from the digital camera 1A. Specifically, the monitors 11 display the manipulation commands as follows: as shown in FIG. 6A, the user of the digital camera 1A selects a window (herein, the window 11B which displays an image of the digital camera 1B) displaying an image captured by a digital camera on which commands are performed by use of the input means 14 in the monitor 11. The color of the frame of the window 11B, which the user selected, is changed. Thereafter, the user employs the input means 14 and presses, for example, a key, which commands to direct to the right side, of the cross key 14A to send data representing a notice thereof to the digital camera 1B. The digital camera 1B determines that the camera should be directed toward the right based on the data, and causes the monitor 11 to display a message “image the right side” as shown in FIG. 6B.

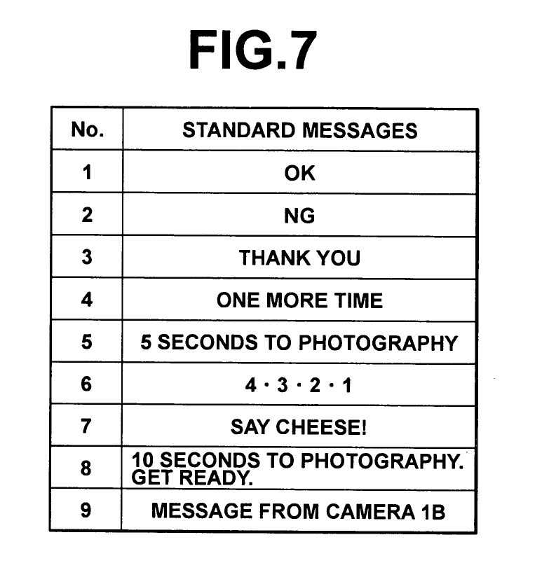

As shown in FIG. 7, standard messages such as “OK,” “Thank You,” “5 seconds to photography,” “Say Cheese,” “Message from Camera 1B” may be stored in a memory card (not shown) of the digital camera 1A. Moreover, the monitor may display the standard messages for the user to select the number, and a text file, which represents the standard messages corresponding to the selected number, may be included in the photography notification data to be sent to the digital cameras 1B to 1D. Accordingly, the monitors 11 of the digital cameras 1B to 1D display the standard messages selected in the digital camera 1A.

After the photography notification is thus performed, the digital camera 1A photographs when the shutter button 12 is pressed completely. At the same time, the digital cameras 1B to 1D photograph. Note that the digital cameras 1B to 1D do not have to photograph at the same time as the digital camera 1A. The digital cameras 1B to 1D may sequentially photograph with a certain time interval.

The wireless LAN chip 13 performs communication via the network 3, the wireless LAN. The wireless LAN chip 13 comprises a memory and a communication interface. The memory stores authentication data required for the communication.

The camera server 2 stores and manages the image data acquired by the digital cameras 1A to 1D. The camera server comprises a large capacity hard disk 2A. When the digital camera 1A photographs, the digital cameras 1B to 1D are caused to photograph. Thus, a total of four image data are acquired by the digital cameras 1A to 1D. These image data are transmitted to the camera server 2 from the digital cameras 1A to 1D to be stored.

In addition, the camera server 2 manages information on the models of the digital cameras 1A to 1D to which the remote control is performed, ID which identifies a camera, and whether the cameras are the master camera or the slave cameras. In the present embodiment, four image data are sent to the camera server 2 by one photography operation. The camera server 2 attaches file names to the image data such that the file names will not overlap and stores the image data. Moreover, the camera server 2 manages the file names to identify the digital camera which acquired the image data to be stored from among the digital cameras 1A to 1D. This will be described in detail later in a second embodiment.

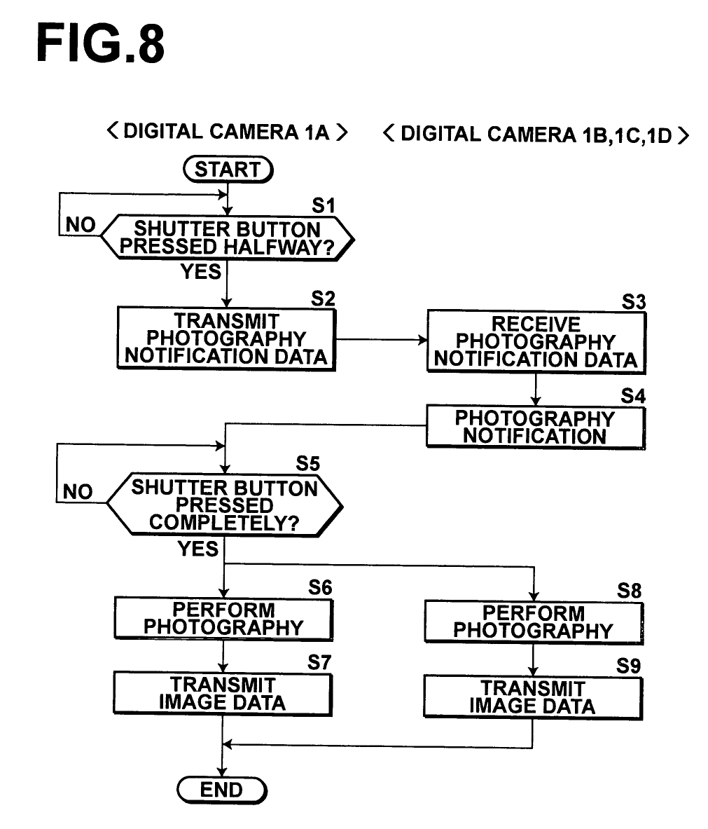

Next, the process performed in the first embodiment will be described. FIG. 8 is a flow chart showing the process performed in the first embodiment. First, the digital camera 1A, the master camera, monitors whether the shutter button 12 is pressed halfway (Step S1). When Step S1 is affirmative, the photography notification means 16 transmits photography notification data to the digital cameras 1B to 1D (Step S2). Second, the digital cameras 1B to 1D receive the photography notification data (Step S3) and perform the photography notification based on the data (Step S4).

Third, the digital camera 1A monitors whether the shutter button 12 is pressed completely (Step S5). When Step S5 is affirmative, the digital camera 1A photographs (Step S6). Image data acquired by the photographing is transmitted to the camera server 2 (Step S7). Simultaneously, other digital cameras 1B to 1D photograph (Step S8). Image data acquired by the photographing are sent to the camera server 2 (Step S9), thereby completing the process.

As described above, the photography notification is performed in the first embodiment when the digital camera 1A instructs the digital cameras 1B to 1D to photograph. Accordingly, the users of the digital cameras 1B to 1D can know in advance that photography is about to take place. Thus, the users are able to direct their cameras toward the object, for example. Therefore, it is possible to ensure that the users of the digital cameras 1B to 1D are made to photograph.

Moreover, the photography notification data are transmitted by pressing the shutter button 12 of the digital camera 1A halfway. Hence, without special operations, it is possible to notify the users of the digital cameras 1B to 1D of the photography.

In the first embodiment, the photography notification data are sent by pressing the shutter button 12 halfway. However, a button, dedicated to sending the photography notification data, may be provided on the input means 14, and the photography notification data may be sent by pressing the button. Alternatively, the monitor 11 may display a menu for transmitting the photography notification data, and the photography notification data may be sent based on the menu.

Furthermore, in the first embodiment, the photography notification data are sent from the digital camera 1A to the digital cameras 1B to 1D. However, it is also possible to select a desired digital camera from the digital cameras 1B to 1D in the digital camera 1A and send the photography notification data only to the selected digital camera. More specifically, a desired window is selected from the windows 11B to 11D displayed on the monitor 11 by use of the input means 14. Accordingly, a desired camera can be selected from among the digital cameras 1B to 1D, to which the photography notification data is sent.

Next, the process to attach a file name to image data is described as the second embodiment.

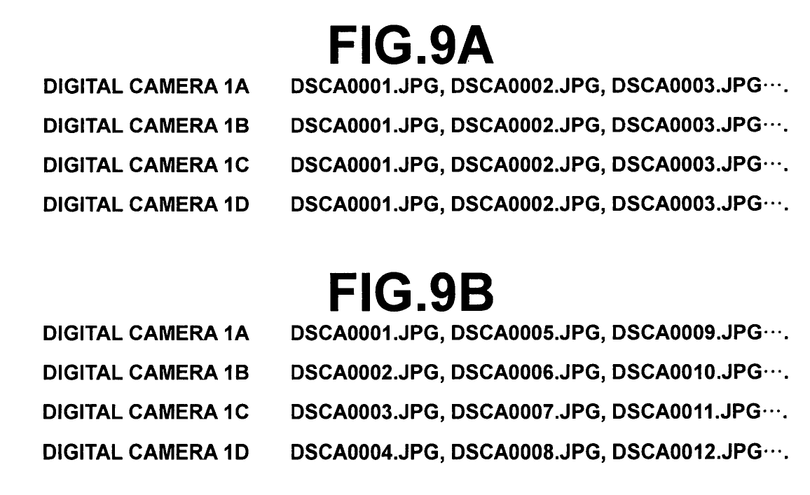

Normally, file names are serially attached to image data acquired by each of the digital cameras 1A to 1D. For instance, as shown in FIG. 9A, the same file name is attached to the image data simultaneously acquired by the digital cameras 1A to 1D. Thus, it is necessary for an operator of the camera server 2 to change the file names because the file names will overlap when the image data acquired by the digital cameras 1A to 1D are sent to the camera server 2 to be stored. Moreover, there is a possibility that an image data having the same file name as another will be overwritten by the other and erased.

Accordingly, file names are attached to the image data in the digital cameras 1A to 1D in accordance with the number of the digital cameras constituting the remote camera system so that the file names of the image data will not overlap when stored in the camera server 2. For example, four digital cameras 1A to 1D are employed in the present embodiment, and thus, as shown in FIG. 9B, the file names in which the figures are incremented by 4 in accordance with an increase in the number of photography are attached. In the digital camera 1A, the file names are attached as DSCA0001.JPG, DSCA0005.JPG, DSCA0009.JPG and so on. In the digital camera 1B, the file names are attached as DSCA0002.JPG, DSCA0006.JPG, DSCA0010.JPG and so on. In the digital camera 1C, the file names are attached as DSCA0003.JPG, DSCA0007.JPG, DSCA0011.JPG and so on. In the digital camera 1D, the file names are attached as DSCA0004.JPG, DSCA0008.JPG, DSCA0012.JPG and so on.

Alternatively, the file names shown in FIG. 9A or temporary file names such as TMP0002.JPG are attached to the image data in the digital cameras 1A to 1D. When the image data are sent to the camera server 2 to be stored, the operator of the camera server 2 may change the file name of the image data as shown in FIG. 9B.

The camera server 2 manages the file names as well as information on the models of the digital cameras 1A to 1D, ID's which identify the cameras, and whether the digital cameras 1A to 1D are the master camera or the slave cameras, storage locations of the image data and the like. These pieces of information are managed by a file name management list stored in the camera server 2.

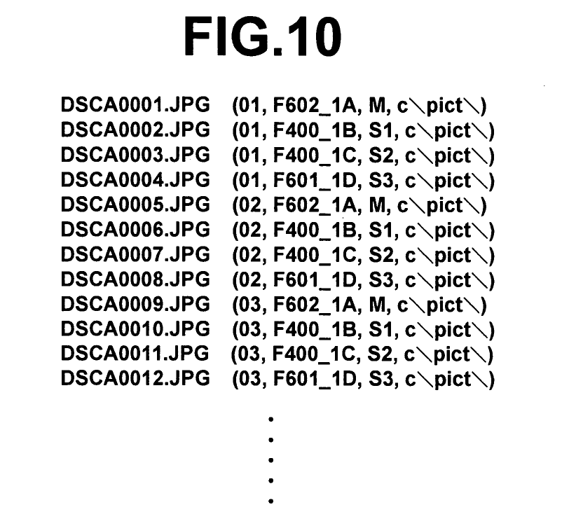

FIG. 10 is a diagram showing the file name management list. As shown in FIG. 10, the file name management list includes a list of the file names of the image data stored in the camera server 2. Photography command information, camera model information, master slave information and storage location information are attached to each file name. The photography command information indicates whether the image data is acquired by the same photography command or by stand-alone photography. The camera model information indicates the camera model and camera ID. The master slave information indicates whether the digital camera is a master or a slave camera. The storage location information indicates a folder name of a storage location for the image data.

The photography command information is represented by symbols or numerals such as “01.” In FIG. 10, “01” is attached to DSCA0001.JPG, DSCA0002.JPG, DSCA0003.JPG and DSCA0004.JPG. “02” is attached to DSCA0005.JPG, DSCA0006.JPG, DSCA0007.JPG and DSCA0008.JPG. “03” is attached to DSCA0009.JPG, DSCA0010.JPG, DSCA0011.JPG and DSCA0012.JPG. Thus, it is clear that the image data attached with the same photography command information are acquired in one photography operation. When the digital cameras 1A to 1D photograph independently, “0” is attached to the column of the photography command information, or the column is left blank. Herein, the photography command information is attached to a header of the image data, a tag of Exif (when the image data has Exif format) or the like.

Model names and camera IDs are combined to constitute the camera model information. More specifically, the model names (F602, F400 and F601 in the second embodiment) such as “F602_{—}1A” (digital camera 1A), “F400_{—}1B” (digital camera 1B), “F400_{—}1C” (digital camera 1C) and “F601_{—}1D” (digital camera 1D) and the camera IDs (1A to 1D in the second embodiment) are combined to constitute the camera model information.

The master slave information is constituted of symbol M which indicates a master camera and symbols S1, S2 and S3 which indicate slave cameras.

The storage location information is constituted of a folder name such as “c:/pict/.”

When new image data are sent to the camera server 2 to be stored, the new stored image data are added to the list. Thus, the file name management list is updated.

As described above, there are cases where the digital cameras 1A to 1D photograph independently, and the image data are sent to the camera server 2. Thus, after photographing, the digital cameras 1A to 1D may access the camera server 2 to receive file names from the camera server 2, in which the file names are consecutive to the file names of the image data already stored in the camera server 2. In this case, the camera server 2 may update the file name management list when the file names are given to the digital cameras 1A to 1D. However, it is preferable to update the file name management list after confirming that the file names are attached to the image data in the digital cameras 1A to 1D. This confirmation may be performed based on the information representing the notice thereof sent to the camera server 2 from the digital cameras 1A to 1D. Alternatively, the confirmation can be also performed when the image data sent from the digital cameras 1A to 1D are received.

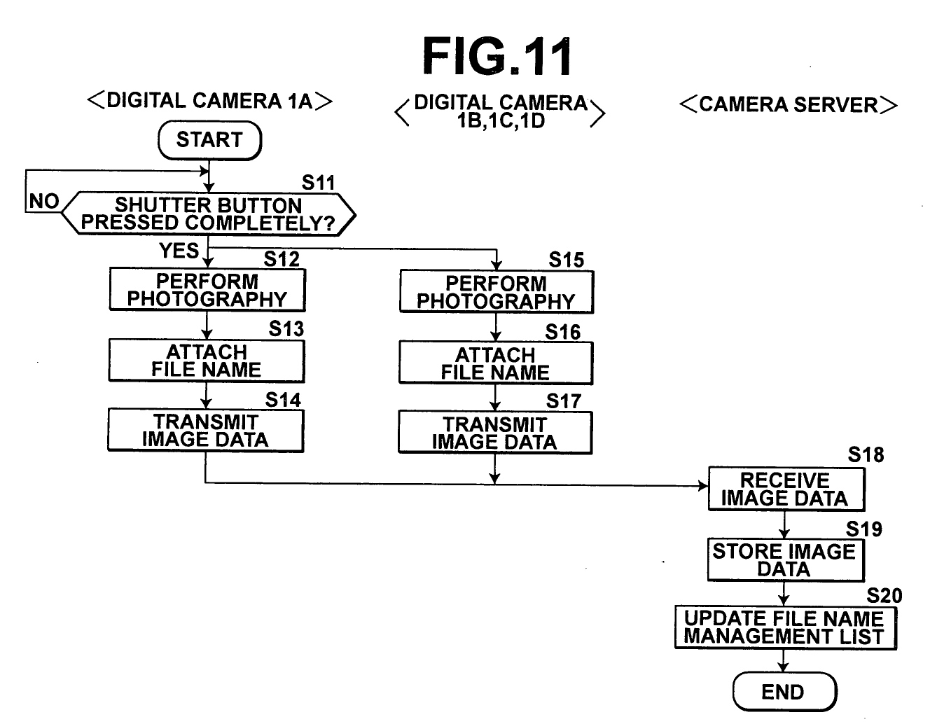

Subsequently, the process performed in the second embodiment will be described. FIG. 11 is a flow chart showing the process performed in the second embodiment. First, the digital camera 1A, the master camera, monitors whether the photography command has been performed by pressing the shutter button 12 completely (Step S11). When Step S11 is affirmative, the digital camera 1A photographs (Step S12). File names are attached to the image data acquired by the photographing (Step S13), and the image data attached with the file names are transmitted to the camera server 2 (Step S14).

At the same time, other digital cameras 1B to 1D photograph (Step S15), and file names are attached to the image data acquired by the photographing (Step S16). The image data attached with the file names are transmitted to the camera server 2 (Step S17).

As shown in FIG. 9B, the file names are attached to the image data so that the file names will not overlap when the image data are stored in the camera server 2.

Thereafter, the camera server 2 receives the image data (Step S18) and stores the received image data (Step S19). Moreover, the camera server 2 updates the file name management list (Step S20), thereby completing the processing.

As described above, in the second embodiment, different file names are attached to each image data acquired by the digital cameras 1A to 1D so that the file names will not overlap and the image data are collectively stored in the camera server 2. Consequently, the file names will not overlap, and it becomes unnecessary for the operator of the camera server 2 to change the file names upon storage. Moreover, it is possible to prevent the image data from being erased due to overwriting.

Since the camera server 2 manages the file name management list, it is easy to know the digital camera and the operation which acquired the image data stored in the camera server 2 by referencing the file name management list.

Although the camera server 2 stores the image data acquired by the digital cameras 1A to 1D in the foregoing second embodiment, the camera server 2 may store the file name management list only, and the digital cameras 1A to 1D may store the image data acquired by their own camera.

In this case, the same file names shown in FIG. 9A may be attached to the image data simultaneously acquired by the digital cameras 1A to 1D, unlike the case where the camera server 2 stores the image data acquired by the digital cameras 1A to 1D.

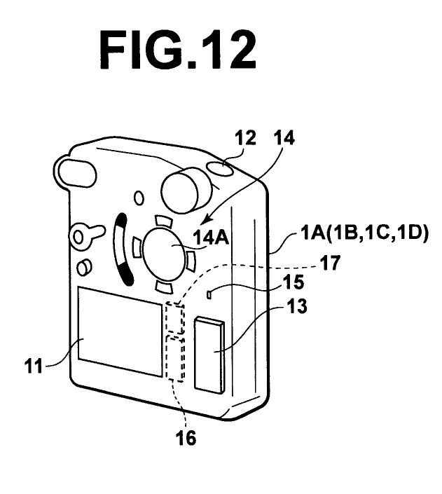

Next, described as a third embodiment is the process to process image data in accordance with display characteristics of display means. FIG. 12 is a rear perspective view showing the configuration of a digital camera 1A used in the third embodiment. Note that, since the digital cameras 1B to 1D have the same configuration as the digital camera 1A, descriptions thereof are omitted. As shown in FIG. 12, the digital camera 1A used in the third embodiment is the digital camera 1A shown in FIG. 2 with an addition of image processing means 17 which processes the image data acquired by photographing.

The image processing means 17 processes image data acquired by photographing in accordance with the display characteristics of the monitor 11 to acquire the processed image data. To be more specific, the image processing means 17 performs resolution conversion, gradation correction, color correction, density correction, enlargement/reduction and trimming on the image data acquired by photographing in accordance with the resolution, gradation characteristics, color reproduction characteristics, size and aspect ratio of the monitor 11. The image processing means 17 thus acquires the processed image data. In the present embodiment, the monitor 11 of the digital camera 1A, the master camera, displays the images, and other digital cameras 1B to 1D process the acquired image data in accordance with the display characteristics of the monitor 11 of the digital camera 1A.

The camera server 2 stores and manages the image data (already processed) acquired by the digital cameras 1A to 1D.

In the third embodiment, the digital camera 1A, the master camera, is required to confirm the image data acquired by other digital cameras 1B to 1D. Accordingly, the camera server 2 sends the digital camera 1A only the image data transmitted from the digital cameras 1B to 1D among the image data transmitted from the digital cameras 1A to 1D.

Instead of sending the image data, a URL indicating the storage location of the image data (e.g., folder name of the hard disk 2A) may be sent to the digital camera 1A. In this case, the user of the digital camera 1A who has received the URL can access the URL to download the image data acquired by the digital cameras 1B to 1D.

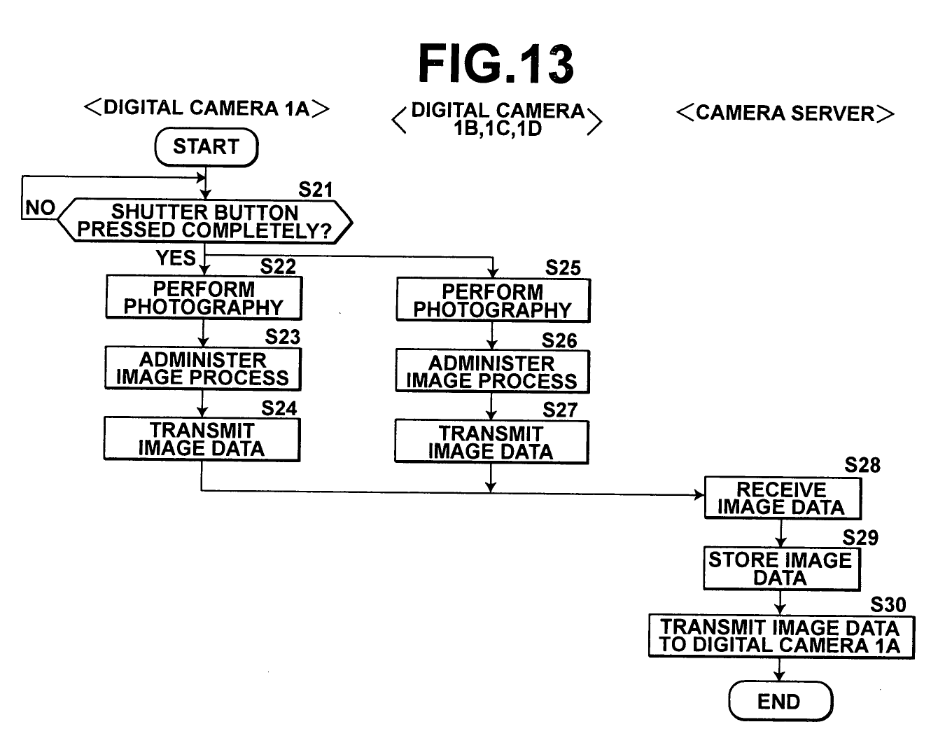

Next, the process performed in the third embodiment will be described. FIG. 13 is a flow chart showing the process performed in the third embodiment. First, the digital camera 1A, the master camera, monitors whether the photography command has been performed by pressing the shutter button 12 completely (Step S21). When Step S21 is affirmative, the digital camera 1A photographs (Step S22). The image data acquired by the photographing are processed in accordance with the display characteristics of the monitor 11 of the digital camera 1A (Step S23). The processed image data are transmitted to the camera server 2 (Step S24).

At the same time, other digital cameras 1B to 1D photograph (Step S25), and the image data acquired by the photographing are processed in accordance with the display characteristics of the monitor 11 of the digital camera 1A (Step S26). The processed image data are transmitted to the camera server 2 (Step S27).

Thereafter, the camera server 2 receives the image data (Step S28) and stores the received image data (Step S29). Moreover, among the stored image data, only the image data acquired by the digital cameras 1B to 1D are transmitted to the digital camera 1A (Step S30), thereby completing the process.

The monitor 11 of the digital camera 1A displays the image data acquired by the digital cameras 1B to 1D.

As described above, in the third embodiment, the image processing means 17 processes the image data acquired by the digital cameras 1B to 1D in accordance with the display characteristics of the monitor 11 of the digital camera 1A, and the processed image data are sent to the digital camera 1A to be displayed on the monitor 11 of the digital camera 1A. Thus, the monitor 11 of the digital camera 1A can display even the image data acquired by other digital cameras 1B to 1D with high quality by processing the image data in accordance with the display characteristics of the monitor 11 of the digital camera 1A.

Moreover, since the image data are processed in the digital cameras 1B to 1D, the monitor 11 of the digital camera 1A can display the image data immediately after reception thereof. As a result, high quality images can be displayed quickly.

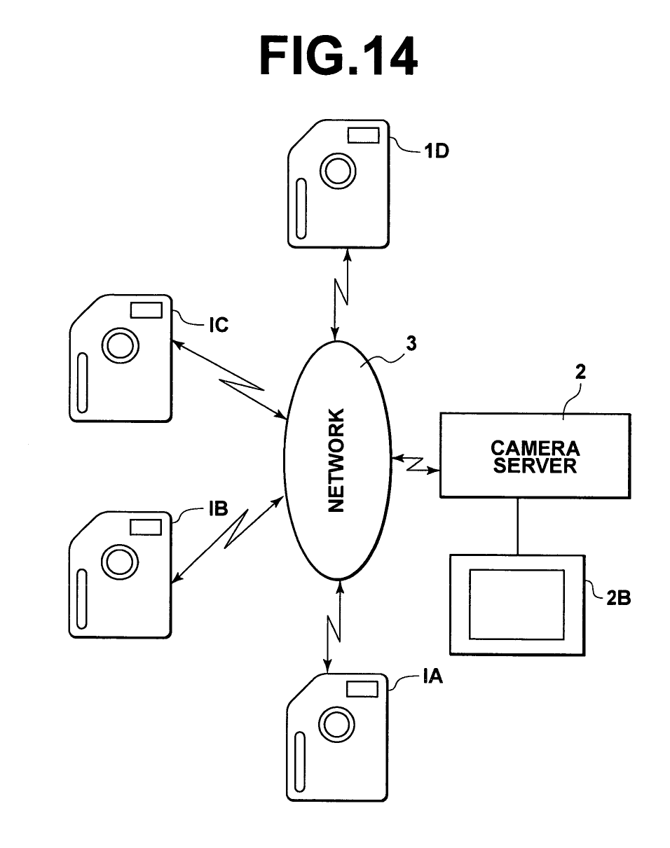

In the foregoing third embodiment, the image data acquired by the digital cameras 1B to 1D are processed in accordance with the display characteristics of the monitor 11 of the digital camera 1A and sent to the digital camera 1A via the camera server 2. However, as shown in FIG. 14, to display the image data on the monitor 2B of the camera server 2, the image processing means 17 of each of the digital cameras 1A to 1D processes the acquired image data in the digital cameras 1A to 1D in accordance with the display characteristics of the monitor 2. Thereafter, the processed image data may be transmitted to the camera server 2. Thus, the monitor 2B of the camera server 2 can display high quality images suited for the display characteristics of the monitor 2B.

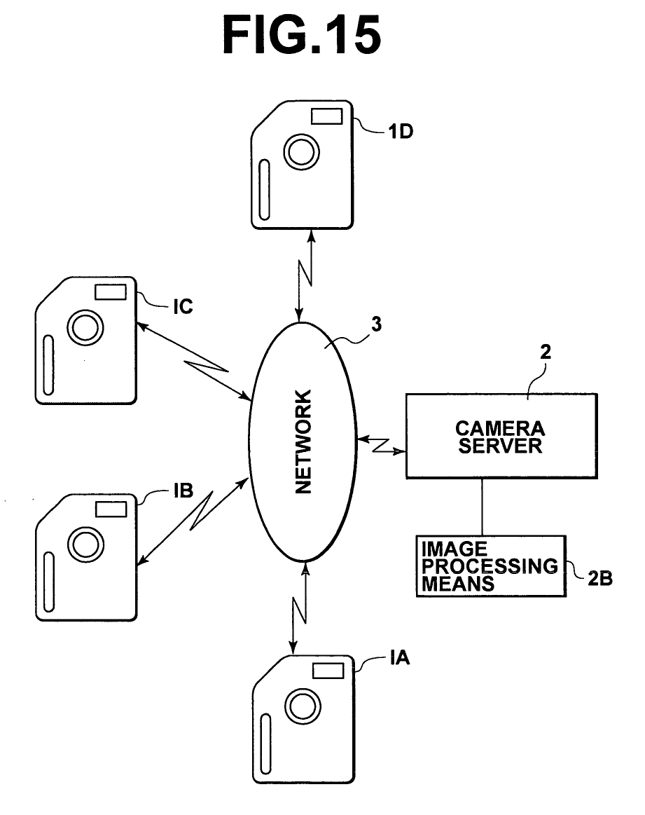

Furthermore, in the foregoing third embodiment, the image processing means 17 is provided in each of the digital cameras 1A to 1D and processes the image data in accordance with the display characteristics of the monitor 11 of the digital camera 1A which displays the image data. However, as shown in FIG. 15, image processing means 2B may be provided in the camera server 2. In this case, the image data acquired by the digital cameras 1A to 1D in photographing are sent to the camera server 2 without being processed. When an image data transmission command is sent to the camera server 2 from any of the digital cameras 1A to 1D, the sending image data are processed by the image processing means 2B in accordance with the display characteristics of the monitor 11 of the digital camera which has sent the transmission command. The processed image data are transmitted to the digital camera which has sent the transmission command. Thus, it is possible to display high quality images on the monitor 11 of the digital camera, which has sent the image data transmission command, in accordance with the display characteristics of that monitor 11. In this case, it is unnecessary to provide the image processing means 17 in the digital cameras 1A to 1D, thereby simplifying the configuration of the digital cameras 1A to 1D.

Moreover, in the third embodiment, the image data can be directly sent to one arbitrary slave camera to be stored therein from other slave cameras and the digital camera 1A, the master camera. In this case, the image data are processed in each of the digital cameras in accordance with the display characteristics of the monitor 11 of the arbitrary slave camera.

Next, described as a fourth embodiment is the process to set storage destinations of the image data in each digital camera.

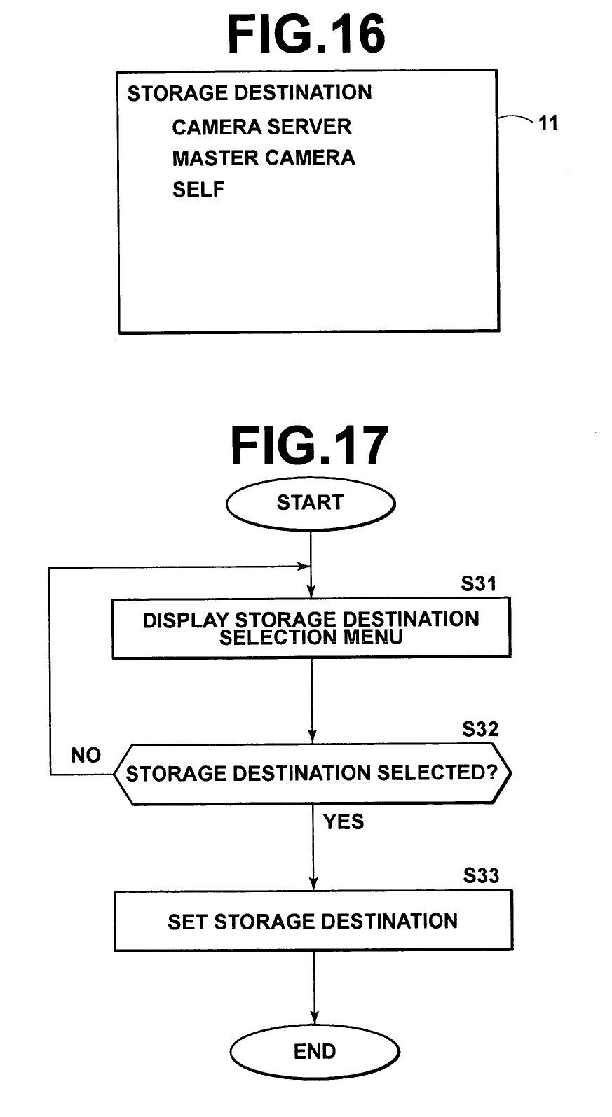

In the fourth embodiment, storage destinations of the image data acquired by the digital cameras 1A to 1D are set by use of the input means 14 of the digital camera 1A. More specifically, the monitor 11 displays a menu for the user to designate the storage destinations, and the user selects the storage destinations from the menu. Thus, the storage destinations are set. FIG. 16 is a diagram showing a storage destination selection menu displayed on the monitor 11. As shown in FIG. 16, three destinations, including “camera server,” “master camera” (i.e., digital camera 1A) and “self,” are displayed on the storage destination selection menu. The users of the digital cameras 1A to 1D can designate at least one storage destination of the image data in the storage destination selection menu.

Herein, it is possible to set the storage destinations separately for both when the digital cameras 1B to 1D, the slave cameras, photograph synchronized with the photography operation of the digital camera A, the master camera, and when the digital cameras 1A to 1D independently photograph. In the former case, the storage destinations can be set as the camera server 2 and/or the self in the digital camera 1A, the master camera. The storage destinations can be set as the camera server 2, the digital camera 1A and/or the self in the digital cameras 1B to 1D, the slave cameras. Note that, the camera server 2 or the digital camera 1A needs to manage the storage locations of the image data when the storage destination is set as the user's own digital camera.

In the latter case, the storage destinations are set as the user's own digital cameras in any of the digital cameras 1A to 1D.

Note that, in the fourth embodiment, the storage destinations of the image data in all the digital cameras 1A to 1D are set as the camera server 2. In this way, the image data are sent from each of the digital cameras 1A to 1D to the camera server 2 and stored therein.

In the case where the digital cameras 1B to 1D, the slave cameras, photograph synchronized with the photography operation of the digital camera 1A, the master camera, the image data are not stored in the camera server 2 when the storage destinations of the image data are set as the users' own digital cameras in all the digital cameras 1A to 1D. However, the information for managing the image data is managed by the camera server 2. Thus, by referencing the information, it is easy to know which digital cameras 1A to 1D store the image data acquired by the digital cameras 1A to 1D.

Subsequently, the process performed in the fourth embodiment will be described. FIG. 17 is a flow chart showing the process performed to set the storage destinations in the fourth embodiment. Note that the process to set the storage destinations is the same in all the digital cameras 1A to 1D.

First, the storage destination selection menu is displayed on the monitor 11 (Step S31). Second, monitoring is initiated whether the selection of the storage destination is received (Step S32). When Step S32 is affirmative, the selected storage destination is set as the storage destination of the image data (Step S33), thereby completing the process.

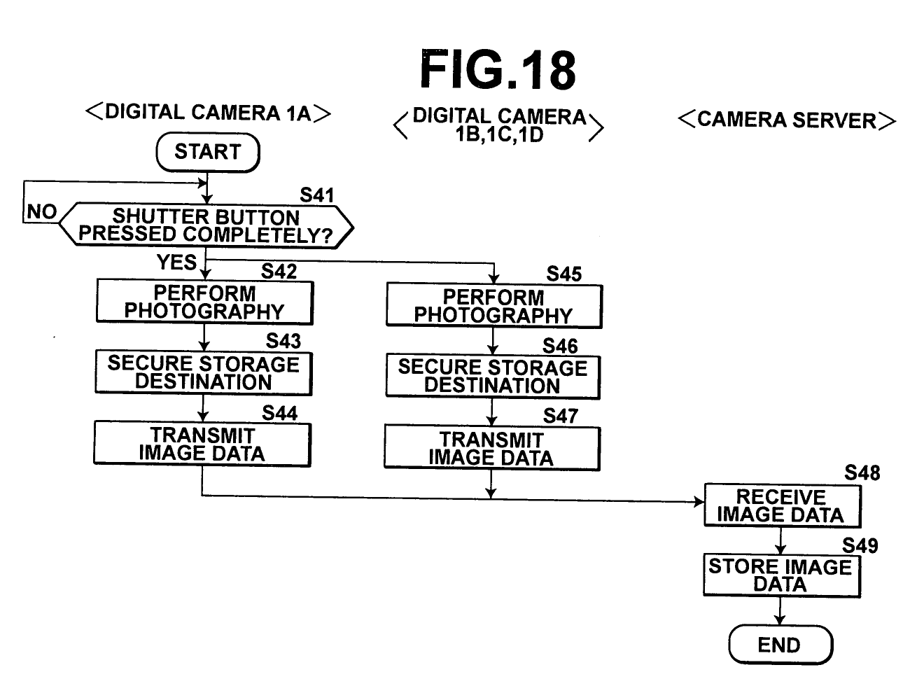

FIG. 18 is a flow chart showing the process to store the image data in the fourth embodiment. First, the digital camera 1A, the master camera, monitors whether the photographing command has been performed by pressing the shutter button 12 completely (Step S41). When Step S41 is affirmative, the digital camera 1A photographs (Step S42). The storage destination of the image data acquired by the photographing is confirmed (Step S43), and the image data is transmitted to the confirmed storage destination (the camera server 2 in the present embodiment) (Step S44).

At the same time, other digital cameras 1B to 1D photograph (Step S45), and the storage destinations of the image data acquired by the photographing are confirmed (Step S46). The image data are transmitted to the camera server 2, the storage destination (Step S47).

Thereafter, the camera server 2 receives the image data (Step S48) and stores the received image data (Step S49), thereby completing the process.

When the storage destination is set as the user's own digital camera in the digital camera 1A, the image data acquired by the photographing is stored in a memory card (not shown) of the digital camera 1A. Meanwhile, when the storage destinations are set as the users' own digital cameras in the digital cameras 1B to 1D, the image data acquired by the photographing are stored in memory cards (not shown) of the digital cameras 1B to 1D. In these cases, the camera server 2 manages the storage destinations of the image data.

On the other hand, when the storage destination is set as the digital camera 1A in the digital cameras 1B to 1D, the image data acquired by the photographing are transmitted to the digital camera 1A and stored therein.

As described above, in the fourth embodiment, storage destinations of the image data acquired by the digital cameras 1A to 1D are set, and the image data acquired in each of the digital cameras 1A to 1D are stored in the storage destinations. Accordingly, it is possible to clarify the storage destinations of the image data acquired by the digital cameras 1A to 1D. Thus, it is easy to find the image data when distributing the image data later on. As a result, it is possible to facilitate the utilization of the image data after storage.

By including the digital camera 1A, the master camera, as the storage destination, the image data acquired by other digital cameras 1B to 1D are stored in the digital camera 1A. Thus, it is easy to manage the image data at the digital camera 1A.

Herein, the image data acquired by the digital cameras 1A to 1D are sent to the camera server 2 in the foregoing fourth embodiment. However, when the available capacity of the camera server 2 is small or none, the image data cannot be stored though the image data is transmitted to the camera server 2. Moreover, the image data cannot be stored in the camera server 2 when the camera server 2 is broken or the network 3 connected to the camera server 2 is interrupted. In these cases, the digital cameras 1A to 1D may accept the changes in the storage destinations. Hereinafter, the process to change the storage destinations will be described. Note that, the process to change the storage destinations is the same in all the digital cameras 1A to 1D.

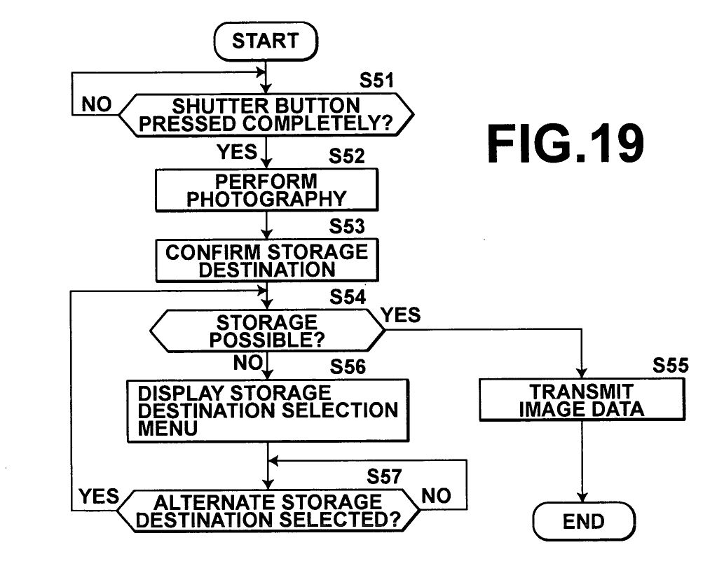

FIG. 19 is a flow chart showing the process to change the storage destinations. First, monitoring is initiated whether the photography command has been performed by pressing the shutter button 12 completely (Step S51). When Step S51 is affirmative, photography takes place (Step S52). The storage destination of the image data acquired by the photography is confirmed (Step S53). Further, it is determined as to whether the confirmed storage destination is able to store the image data (Step S54). This determination is performed by confirming the available capacity of the storage destination and the communication status with the storage destination.

When Step S54 is affirmative, the image data is transmitted to the camera server 2 which is the confirmed storage destination (Step S55), thereby completing the process.

When Step S54 is denied, the storage destination selection menu shown in FIG. 16 is displayed on the monitor 11 (Step S56). Subsequently, monitoring is initiated whether an alternate storage destination is selected (Step S57). When Step S57 is affirmative, the process goes back to Step S54, and the steps thereafter are repeated.

As described above, it is possible to avoid the situation where the image data cannot be stored by accepting the changes in the storage destinations when the image data cannot be stored in the storage destination.

In the foregoing fourth embodiment, the image data may be directly sent to one arbitrary slave camera to be stored from other slave cameras and the digital camera 1A, the master camera. In this case, the arbitrary slave camera is set as the storage destination in other slave cameras and the digital camera 1A, the master camera.

Next, described as a fifth embodiment is the process to change display modes in various ways when displaying a plurality of the image data acquired by each digital camera.

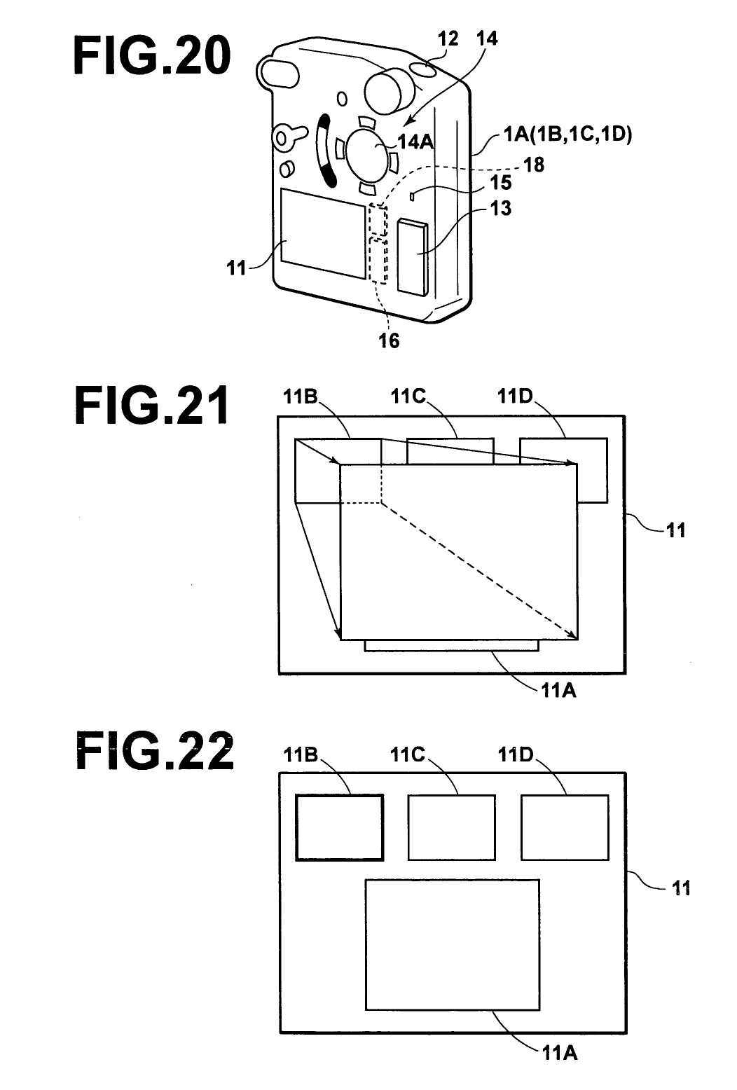

FIG. 20 is a rear perspective view showing the configuration of a digital camera 1A used in the fifth embodiment. Note that, since digital cameras 1B to 1D have the same configuration as the digital camera 1A, descriptions thereof are omitted. As shown in FIG. 20, the digital camera 1A used in the fifth embodiment is the digital camera 1A shown in FIG. 2 with an addition of display control means 18 for controlling the display of a monitor 11.

The monitor 11 displays both an image that the digital camera 1A is about to photograph and images that the digital cameras 1B to 1D are about to photograph. The display is controlled by the display control means 18.

In other words, as shown in FIGS. 3 and 4, the display control means 18 performs the process to display the images acquired by each of the digital cameras 1A to 1D.

Note that, as shown in FIG. 21, a window selected from the windows 11A to 11D may be enlarged to be displayed (11B is selected herein).

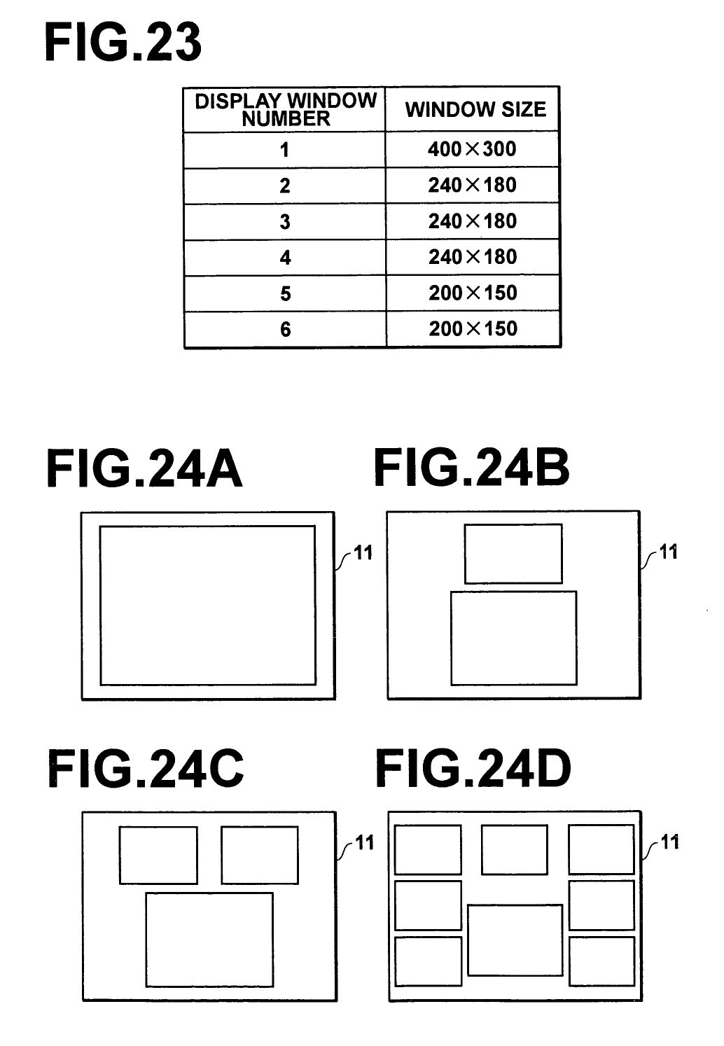

The digital cameras 1B to 1D photograph in synchronization with the photography operation of the digital table shows relationships between the number of display windows and the window sizes. The window size (in this case, the size of 11A) is determined based on the number of the display windows by referencing the table. After the size of the window 11A is determined, the sizes of other windows 11B, 11C and 11D are determined so that the other windows 11B, 11C and 11D are arranged to be displayed with the maximum feasible size in a region outside the window 11A on the monitor 11. Note that the table shown in FIG. 23 can be overwritten by the user of the digital camera 1A arbitrarily.

Herein, when the number of the display windows is four, the windows 11A to 11D may be arranged as shown in FIG. 3. However, arrangements of the windows are different depending on the number of the display windows. For example, when the number of the display windows is one, two, three and eight, the windows are arranged as shown in FIGS. 24A to 24D, respectively. It is preferable to retain the aspect ratio of the images even when the number of the display windows is different.

Incidentally, the monitors 11 of the digital cameras 1B to 1D, the slave cameras, also display the windows 11A to 11D. The window 11A displays the image that the digital camera 1A is about to photograph, and the windows 11B to 11D display the images that the digital cameras 1B to 1D are about to photograph. However, the image that the user's own digital camera is about to photograph is displayed with larger window size than images that the other digital cameras are about to photograph.

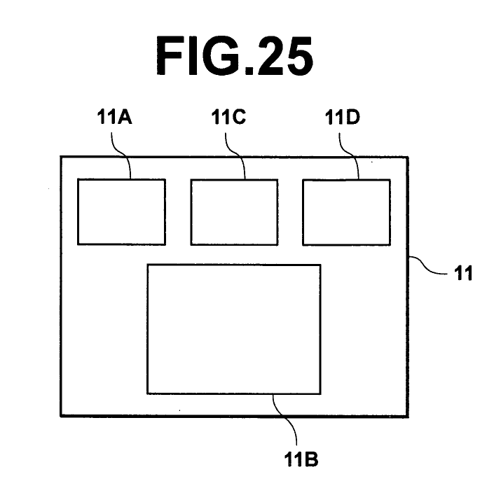

For instance, the monitor 11 of the digital camera 1B displays the window 11B larger than the windows 11A, 11C and 11D as shown in FIG. 25. The window 11B displays the image that the digital camera 1B is about to photograph, and the windows 11A, 11C and 11D display the images that other digital cameras 1A, 1C and 1D are about to photograph.

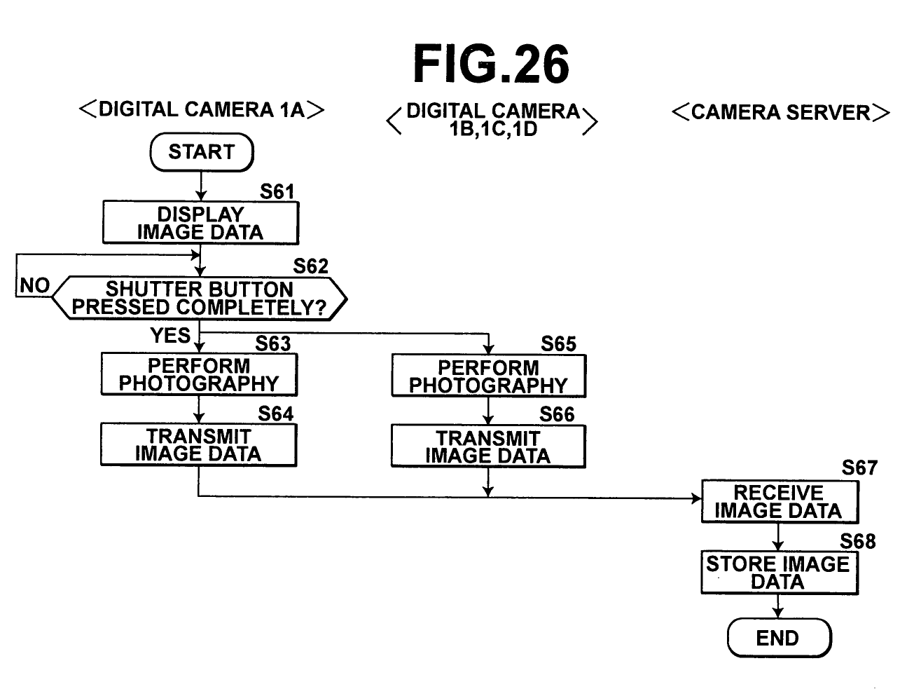

Next, the process performed in the fifth embodiment is described. FIG. 26 is a flow chart showing the process to store the image data in the camera server 2 in the fifth embodiment. First, the monitor 11 of the digital camera 1A displays images that the digital cameras 1A to 1D are about to photograph, as shown in FIG. 3 and the like (Step S61). Note that the images which the digital cameras 1A to 1D are about to photograph are also displayed on the monitors 11 of other digital cameras 1B to 1D at the same time. The user of the digital camera 1A presses the shutter button 12 at a photo opportunity while watching the monitor 11. The digital camera 1A monitors whether the photography command has been performed by pressing the shutter button 12 completely (Step S62). When Step S62 is affirmative, the digital camera 1A photographs (Step S63). The image data acquired by the photographing is transmitted to the camera server 2 (Step S64).

At the same time, other digital cameras 1B to 1D photograph (Step S65). The image data acquired by the photographing are transmitted to the camera server 2 (Step S66).

Thereafter, the camera server 2 receives the image data (Step S67) and stores the received image data (Step S68), thereby completing the process.

As described above, in the fifth embodiment, a plurality of images represented by a plurality of image data that the digital cameras 1A to 1D are about to photograph are displayed on the monitor 11 of the digital camera 1A, the master camera. In this case, the image that the digital camera 1A is about to photograph is displayed on the monitor 11 by the window 1A which has the larger size than the windows 11B to 11D of the images that other digital cameras 1B to 1D are about to photograph. Thus, by looking at a plurality of images displayed on the monitor 11 of the digital camera 1A, it is easy to recognize an image that the digital camera 1A is about to photograph.

In the foregoing fifth embodiment, the monitor 2B may display the images acquired by the digital cameras 1A to 1D when the monitor 2B is provided in the camera server 2 as shown in the aforementioned FIG. 14. In this case, the images that a desired digital camera (in this case, 1A) designated by the camera server 2 is about to photograph is displayed on the window 11A, which is larger than the windows 11B to 11D of images that other digital cameras 1B to 1D are about to photograph.

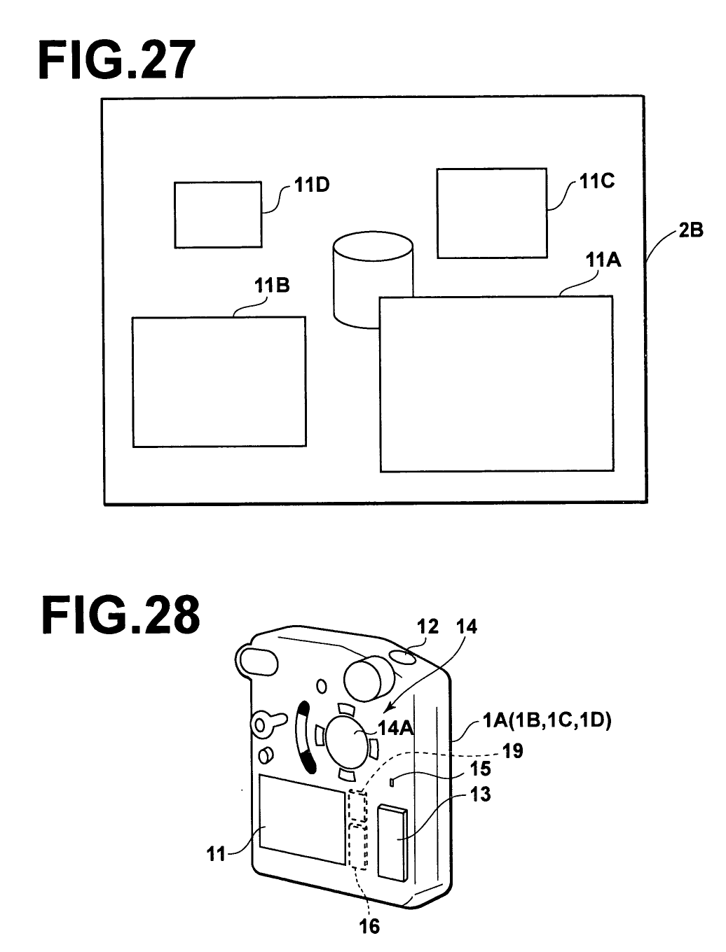

Furthermore, in accordance with the distances between the digital cameras 1A to 1D and the object, the sizes of the windows 11A to 11D may be changed to be displayed on the monitor 2B. In this case, the locations of the digital cameras 1A to 1D are detected, and distances between the digital cameras 1A to 1D and the object are measured based on the positional relationships among the digital cameras 1A to 1D. FIG. 27 is a diagram showing an example of windows displayed on the monitor 2B in accordance with the distances between the digital cameras 1A to 1D and the object. In FIG. 27, as the digital cameras 1A to 1D are located closer to the object, windows displaying the images that the digital cameras 1A to 1D are about to photograph are larger in size. Herein, in FIG. 27, since the sizes of the windows are reduced in the order of the windows 11A, 11B, 11C and 11D, it is clear that the digital camera 1A is located closest to the object, the digital cameras 1B, 1C and 1D are located farther away from the object in this order. Note that the object is a cylindrical figure shown in the center of the monitor 2B.

Instead of the monitor 2B, the monitors 11 of the digital cameras 11A to 11D may display the images shown in FIG. 27.

Herein, the locations of the digital cameras 1A to 1D can be detected by the camera server 2 as follows: GPS means may be provided in each of the digital cameras 1A to 1D to receive measuring radio waves from a GPS satellite and output the waves as GPS information; and accordingly, the digital cameras 1A to 1D send the acquired GPS information to the camera server 2. Thereafter, a location of the object is calculated based on the positional relationship among the digital cameras 1A to 1D. With reference to the location of the object, the distances between the object and the digital cameras 1A to 1D are measured. Thus, the sizes of the windows 11A to 11D are determined.

Moreover, the locations of the users' own cameras can be inputted from the input means 14 of the digital cameras 1A to 1D. These inputted locations can be defined as positional information and sent to the camera server 2, thereby detecting the locations of the digital cameras 1A to 1D in the camera server 2.

It is also possible to provide the digital cameras 1A to 1D with a function to send and receive the radio waves to and from the mobile phone communication network. In this case, the radio waves are received at base stations of the mobile phone communication network. The camera server 2 may obtain the information on the intensity of the radio waves from the operating company of the mobile phone communication network to detect the locations of the digital cameras 1A to 1D.

Next, described as a sixth embodiment is the process to synchronize time among the digital cameras 1A to 1D. FIG. 28 is a rear perspective view showing the configuration of a digital camera 1A used in the sixth embodiment. Note that since the digital cameras 1B to 1D have the same configuration as the digital camera 1A, descriptions thereof are omitted. As shown in FIG. 28, the digital camera 1A used in the sixth embodiment is the digital camera 1A shown in FIG. 2 with an addition of timer means 19. The timer means 19 functions as a clock and outputs time synchronization signals to the network 3 via the wireless LAN chip 13. The time synchronization signals are for the input means 14 to perform time synchronization.

The timer means 19 functions as a clock to attach photography date/time data to the image data acquired by photographing. The photography date/time data represents photography time. In addition, the timer means 19 outputs time synchronization signals for synchronizing the time indicated by the timer means 19 of the digital camera 1A with the times indicated by the timer means 19 of other digital cameras 1B to 1D. These time synchronization signals are transmitted to the digital cameras 1B to 1D from the wireless LAN chip 13 via the network 3. The timer means 19 of the digital cameras 1B to 1D perform time synchronization based on the received time synchronization signals. Accordingly, the times indicated by the timer means 19 of all the digital cameras 1A to 1D can be synchronized with the time indicated by the timer means 19 of the digital camera 1A.

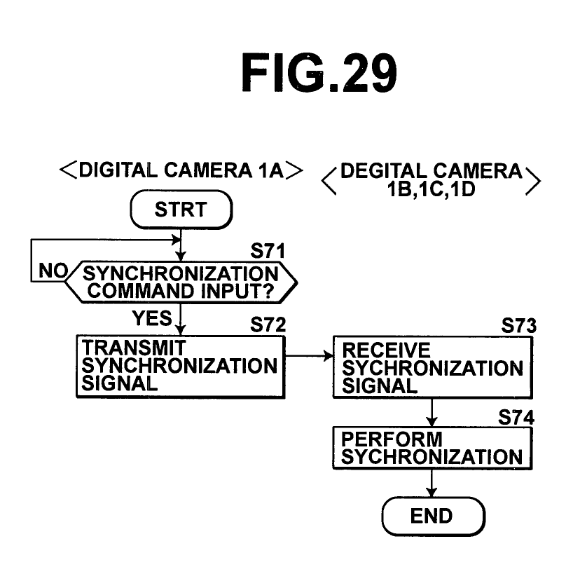

Next, the process performed in the sixth embodiment is described. FIG. 29 is a flow chart showing the process to perform time synchronization in the sixth embodiment. First, the digital camera 1A, the master camera, monitors whether synchronization commands have been inputted by the input means 14 (Step S71). When Step S71 is affirmative, time synchronization signals are outputted from the timer means 19 and transmitted to the digital cameras 1B to 1D, the slave cameras, from the wireless LAN chip 3 via the network 3 (Step S72) The digital cameras 1B to 1D receive the time synchronization signals (Step S73). The timer means 19 of the digital cameras 1B to 1D perform time synchronization based on the time synchronization signals (Step 74), thereby completing the process.

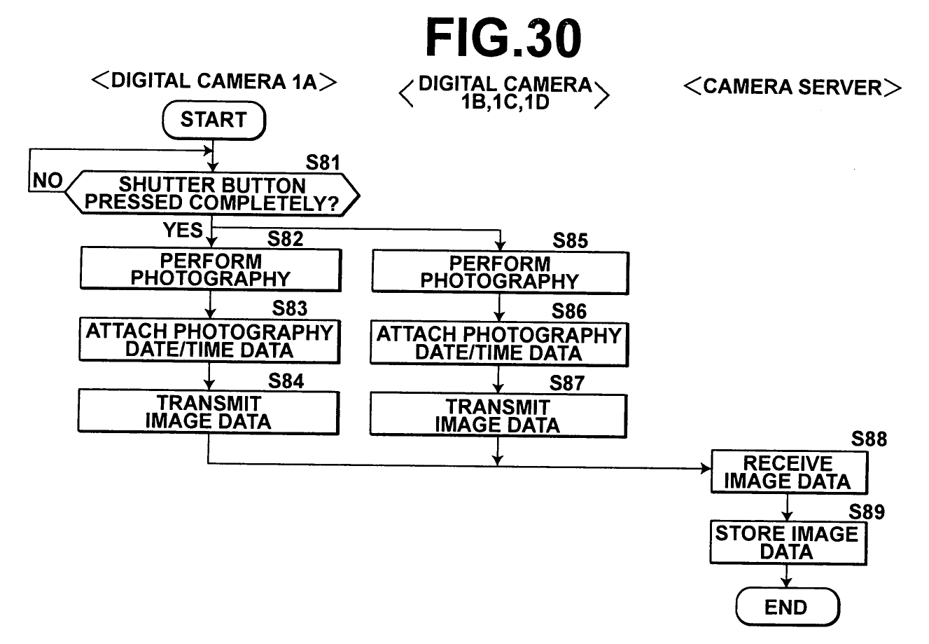

FIG. 30 is a flow chart showing the process upon photographing in the sixth embodiment. First, the digital camera 1A monitors whether the photography command has been performed by pressing the shutter button 12 completely (Step S81). When Step S81 is affirmative, the digital camera 1A photographs (Step S82). Photography date/time data is attached to the image data, acquired by photographing, by referencing the timer means 19 (Step S83). The image data attached with the photography date/time data is sent to the camera server 2 (Step S84).

At the same time, the other digital cameras 1B to 1D photograph (Step S85). Photography date/time data is attached to the image data, acquired by photographing, by referencing the timer means 19 (Step S86). The image data attached with the photography date/time data are sent to the camera server 2 (Step S87).

The camera server 2 receives the image data (Step S88) and stores the received image data (Step S89), thereby completing the process.

As described above, in the sixth embodiment, the times of all the digital cameras 1A to 1D can be synchronized. Hence, the photography time represented by the photography date/time data attached to the image data acquired by the digital cameras 1A to 1D agree with the photography time calculated with reference to the time indicated by the timer means 19 of the digital camera 1A. Therefore, by arranging the image data stored in the camera server 2 based on the photography date/time data attached to the image data, it is possible to precisely sort the image data in the actual order of photography.

In addition, time synchronization signals are transmitted to the digital cameras 1B to 1D based on the input by the input means 14 of the digital camera 1A, the master camera. Based on these time synchronization signals, the timer means 19 of the digital cameras 1B to 1D are synchronized. Thus, it is possible to ensure that the photography time represented by the photography date/time data attached to the image data acquired by the digital cameras 1A to 1D agree with the photography time calculated with reference to the time indicated by the timer means 19 of the digital camera 1A.

In the foregoing sixth embodiment, the time synchronization signals are transmitted to the digital cameras 1B to 1D based on the input of the time synchronization command by the input means 14 in the digital camera 1A. Accordingly, the timer means 19 of the digital cameras 1A to 1D are synchronized. However, the timer means 19 of the digital cameras 1A to 1D may be synchronized without input of the time synchronization commands. For example, the time synchronization signals may be transmitted to the digital cameras 1B to 1D at certain time intervals or at predetermined times with reference to the timer means 19 of the digital camera 1A.

In the sixth embodiment, the times indicated by the timer means 19 of the digital cameras 1B to 1D are synchronized with the time indicated by the timer means 19 of the digital camera 1A. However, the times indicated by the timer means 19 of the digital cameras 1A to 1D may be synchronized with the time of the camera server 2 by transmitting the time synchronization signals from the camera server 2 to the digital cameras 1A to 1D.

In the sixth embodiment, the times indicated by the timer means 19 of the digital cameras 1B to 1D are synchronized with the time indicated by the timer means 19 of the digital camera 1A. However, GPS means for receiving measuring radio waves from a GPS satellite may be provided in the digital cameras 1A to 1D to synchronize the times of the timer means 19 of the digital cameras 1A to 1D based on time information included in the measuring radio waves. Note that the measuring radio waves are received when signals are transmitted to the digital cameras 1B to 1D to make the digital cameras 1B to 1D receive the measuring radio waves based on the operation of input means 14 in the digital camera 1A. The measuring radio waves may be also received at certain time intervals or predetermined times.

In addition, the timer means 19 may be provided with a function to receive standardizing waves having time information, and the time synchronization can be performed by receiving the standard waves. Note that the standardizing waves are received when signals are transmitted to the digital cameras 1B to 1D to make the digital cameras 1B to 1D receive the standardizing waves based on the operation of input means 14 in the digital camera 1A. The standardizing waves may be also received at certain time intervals or predetermined times.

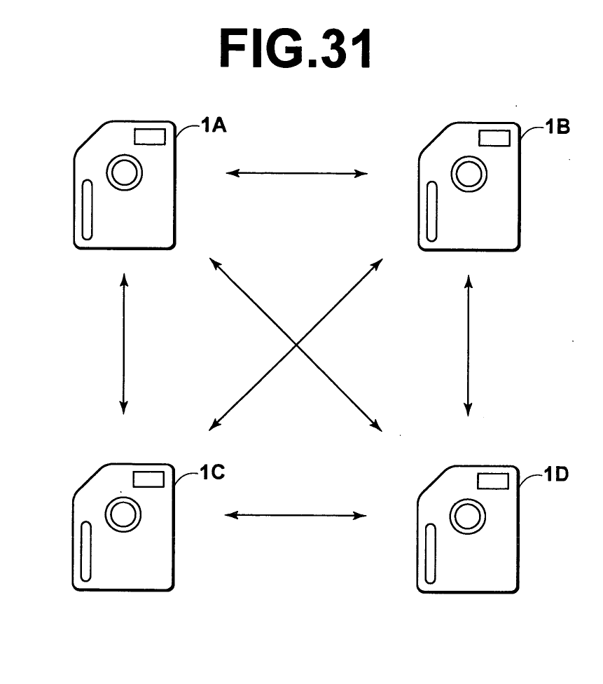

In the first to sixth embodiments, the camera server 2 stores the image data acquired by the digital cameras 1A to 1D. However, the digital camera 1A, the master camera, may store the image data acquired by itself and other digital cameras 1B to 1D, without providing the camera server 2. In this case, the image data are directly transmitted to the digital camera 1A from the digital cameras 1B to 1D. Alternatively, one arbitrary slave camera may store the image data directly sent from other slave cameras and the digital camera 1A, the master camera. In this case, as shown in FIG. 31, a peer-to-peer communication system is employed for the communications among the digital cameras 1A to 1D so that the digital cameras 1A to 1D may directly exchange data. Note that, in the peer-to-peer communication system, data transfer between the digital cameras 1A to 1D is performed by directly transferring information packets to a receiver digital camera from a digital camera which sends the data.

Particularly in the third embodiment, when the digital cameras 1A to 1D exchange data directly, the unprocessed image data are sent to the digital camera 1A from the digital cameras 1B to 1D. Accordingly, the image data acquired by the digital camera 1A and other digital cameras 1B to 1D may be processed at the digital camera 1A. Moreover, it is possible to select at the digital camera 1B to 1D as to whether to process the image data at the digital cameras 1B to 1D or to send the image data to the digital camera 1A to be processed. Specifically, it is determined at the digital cameras 1B to 1D as to whether the image data are sent to the digital camera 1A to be processed or processed at the digital cameras 1B to 1D in accordance with the display characteristics and/or the communication capabilities of the digital camera 1A. This determination is carried out by the image processing means 17. As a result, for example, when the communication capabilities of the digital camera 1A is low, the quantities of data may be reduced by lowering the resolution of the images represented by the image data, which are acquired by the digital cameras 1B to 1D. The image data showing the images with the lowered resolution are sent to the digital camera 1A. Hence, it is possible to send the image data efficiently, reducing a communication load applied to the digital camera 1A.

In addition, in the first to sixth embodiments, the relationships between the master camera and the slave cameras may be arbitrarily changed at the digital cameras 1A to 1D.

Furthermore, in the first to sixth embodiments, the remote camera system employing the digital cameras 1A to 1D is described. However, it is possible to constitute the remote camera system by use of mobile terminal devices with cameras such as mobile phones and PDAs. In this case, the mobile terminal devices with cameras and digital cameras may coexist in the remote camera system. Unlike the digital cameras 1A to 1D, the mobile terminal devices with cameras are not provided with buttons dedicated for performing various operations for photographing, such as a dedicated shutter button. The operation buttons of the mobile terminal devices function as buttons which perform various operations for photographing.

What is claimed is:

1. A method for controlling an imaging device, in which a plurality of imaging devices are associated via a network to be operated,
wherein photography notification data is transmitted to a desired imaging device among the plurality of imaging devices to cause the desired imaging device to perform photography notification when causing the plurality of imaging devices to perform a photography operation.

2. The method for controlling an imaging device according to claim 1, wherein one of the plurality of imaging devices transmits the photography notification data.

3. The method for controlling an imaging device according to claim 2, wherein the photography notification data is transmitted based on the photography operation of the one imaging device.

4. A device for controlling an imaging device, in which a plurality of imaging devices are associated via a network to be operated, the device comprising:
photography notification means for transmitting photography notification data to a desired imaging device among the plurality of imaging devices to cause the desired imaging device to perform photography notification when causing the plurality of imaging devices to perform photography operation.

5. The device for controlling an imaging device according to claim 4, being provided in one of the plurality of imaging devices to be structured.

6. The device for controlling an imaging device according to claim 5, wherein the photography notification data is transmitted based on the photography operation of the one imaging device.

7. A program for causing a computer to execute a method for controlling an imaging device, in which a plurality of imaging devices are associated via a network to be operated, the program causing a computer to execute a procedure for:
transmitting photography notification data to a desired imaging device among the plurality of imaging devices to cause the desired imaging device to perform photography notification when causing the plurality of imaging devices to perform a photography operation.

8. The program according to claim 7, wherein one of the plurality of imaging devices transmits the photography notification data in the procedure to transmit the photography notification data.

9. The program according to claim 8, wherein the photography notification data is transmitted based on the photography operation of the one imaging device in the procedure to transmit the photography notification data.

10. A method for controlling an imaging device, in which a plurality of imaging devices are associated via a network to be operated and each of the plurality of imaging devices photographs to acquire image data by one photography operation,
wherein the plurality of image data acquired by the plurality of imaging devices are collectively managed.

11. The method for controlling an imaging device according to claim 10, wherein a different file name is attached to each of the plurality of image data acquired by the plurality of imaging devices to collectively store the plurality of image data.

12. The method for controlling an imaging device according to claim 10, wherein the plurality of image data are managed based on photography status information indicating a status of when the plurality of image data are photographed.

13. The method for controlling an imaging device according to claim 10, wherein one of the plurality of imaging devices manages the plurality of image data.

14. A device for controlling an imaging device, in which a plurality of imaging devices are associated via a network to be operated and each of the plurality of imaging devices photographs to acquire image data by one photography operation, the device comprising:
management means for collectively managing the plurality of image data acquired by the plurality of imaging devices.

15. The device for controlling an imaging device according to claim 14, wherein the management means comprises storage means for attaching a different file name to each of the plurality of image data acquired by the plurality of imaging devices to collectively store the plurality image data.

16. The device for controlling an imaging device according to claim 14, wherein the management means manages the plurality of image data based on photography status information indicating a status of when the plurality of image data are photographed.

17. The device for controlling an imaging device according to claim 14, being provided in one of the plurality of imaging devices.

18. A program for causing a computer to execute a method for controlling an imaging device, in which a plurality of imaging devices are associated via a network to be operated and each of the plurality of imaging devices photographs to acquire image data by one photography operation, the program causing a computer to execute a procedure for:
collectively managing the plurality of image data acquired by the plurality of imaging devices.

19. The program according to claim 18, further causing a computer to execute a procedure for attaching a different file name to each of the plurality of image data acquired by the plurality of imaging devices to collectively store the image data.

20. The program according to claim 18, wherein the plurality of image data are managed based on photography status information indicating a status of when the plurality of image data are photographed in the managing procedure.

21. A method for controlling an imaging device, in which a plurality of imaging devices are associated via a network to be operated to acquire image data,
wherein the image data are processed and displayed on display means in accordance with display characteristics of the display means for displaying the image data.

22. The method for controlling an imaging device according to claim 21, wherein the processed image data are displayed on one of the plurality of imaging devices.

23. The method for controlling an imaging device according to claim 21, wherein the image data are processed in each of the plurality of imaging devices.

24. The method for controlling an imaging device according to claim 22, wherein the image data are processed in the one imaging device or each of the plurality of imaging devices.

25. The method for controlling an imaging device according to claim 24, wherein whether to process the image data in the one imaging device or each of the plurality of imaging devices is determined in accordance with the display characteristics of the display means of the plurality of imaging devices and/or communication capabilities of the plurality of imaging devices.

26. The method for controlling an imaging device according to claim 21, wherein the display characteristics of the display means include resolution, gradation characteristics, color reproduction characteristics, size and an aspect ratio.

27. A device for controlling an imaging device, in which a plurality of imaging devices are associated via a network to be operated to acquire image data, the device comprising:
image processing means for processing the image data in accordance with display characteristics of display means for displaying the image data.

28. The device for controlling an imaging device according to claim 27, wherein the display means is provided in one of the plurality of imaging devices.

29. The device for controlling an imaging device according to claim 28, being provided in each of the plurality of imaging devices.

30. The device for controlling an imaging device according to claim 29, further comprising control means for controlling the image processing means to process the image data in the one imaging device or each of the plurality of imaging devices.

31. The device for controlling an imaging device according to claim 30, wherein the control means determines whether to process the image data in the one imaging device or each of the plurality of imaging devices in accordance with the display characteristics of the display means of the plurality of imaging devices and/or communication capabilities of the plurality of imaging devices.

32. The device for controlling an imaging device according to claim 27, wherein the display characteristics of the display means include resolution, gradation characteristics, color reproduction characteristics, size and an aspect ratio.

33. A program for causing a computer to execute a method for controlling an imaging device, in which a plurality of imaging devices are associated via a network to be operated to acquire image data, the program causing a computer to execute a procedure for:
processing and displaying the image data on display means in accordance with display characteristics of the display means for displaying the image data.

34. A method for controlling an imaging device, in which a plurality of imaging devices are associated via a network to be operated to acquire image data, the method comprising:
accepting storage destination settings of the image data acquired in each of the plurality of imaging devices; and
storing the image data acquired by each of the plurality of imaging devices in the set storage destination.

35. The method for controlling an imaging device according to claim 34, wherein one of the plurality of imaging devices is included as the storage destination.

36. The method for controlling an imaging device according to claim 34, wherein a change in the storage destination is accepted when the image data cannot be stored in the set storage destination.

37. A device for controlling an imaging device, in which a plurality of imaging devices are associated via a network to be operated to acquire image data, the device comprising:
setting means for accepting storage destination settings of the image data acquired in each of the plurality of imaging devices; and
storage means for storing the image data acquired by each of the plurality of imaging devices in the set storage destination,
wherein the setting means and the storage means are provided in each of the plurality of imaging devices.

38. The device for controlling an imaging device according to claim 37, wherein one of the plurality of imaging devices is included as the storage destination.

39. The device for controlling an imaging device according to claim 37, wherein the setting means accepts a change in the storage destination when the image data cannot be stored in the set storage destination.

40. A program for causing a computer to execute a method for controlling an imaging device, in which a plurality of imaging devices are associated via a network to be operated to acquire image data, the program causing a computer to execute procedures for:
accepting storage destination settings of the image data acquired in each of the plurality of imaging devices; and
storing the image data acquired by each of the plurality of imaging devices in the set storage destinations.

41. The program according to claim 40, wherein one of the plurality of imaging devices is included as the storage destination.

42. The program according to claim 40, further causing a computer to execute a procedure for accepting a change in the storage destination when the image data cannot be stored in the set storage destination.

43. A method for controlling an imaging device, in which a plurality of imaging devices are associated via a network to be operated to acquire image data,
wherein, when a plurality of images represented by the plurality of image data acquired by each of the plurality of imaging devices are displayed on one display means, an image represented by the image data acquired by a desired imaging device and images represented by the image data acquired by other imaging devices are displayed on the display means in different sizes.

44. A method for controlling an imaging device, in which a plurality of imaging devices are associated via a network to be operated to acquire image data,
wherein, when a plurality of images represented by the plurality of image data acquired by each of the plurality of imaging devices are displayed on one display means, the plurality of images are displayed on the display means in different sizes in accordance with distances between the plurality of imaging devices and an object.

45. The method for controlling an imaging device according to claim 43, wherein an image selected from the plurality of displayed images is enlarged and displayed on the display means.

46. The method for controlling an imaging device according to claim 44, wherein an image selected from the plurality of displayed images is enlarged and displayed on the display means.

47. A device for controlling an imaging device, in which a plurality of imaging devices are associated via a network to be operated to acquire image data, the device comprising:
display control means for displaying an image represented by the image data acquired by a desired imaging device and images represented by the image data acquired by other imaging devices on one display means in different sizes when a plurality of images represented by the plurality of image data acquired by each of the plurality of imaging devices are displayed on the display means.

48. A device for controlling an imaging device, in which a plurality of imaging devices are associated via a network to be operated to acquire image data, the device comprising:
display control means for displaying the plurality of images on one display means in different sizes in accordance with distances between the plurality of imaging devices and an object when a plurality of images represented by the plurality of image data acquired by each of the plurality of imaging devices are displayed on the display means.

49. The device for controlling an imaging device according to claim 47, wherein the display control means enlarges and displays an image selected from the plurality of displayed images on the display means.

50. The device for controlling an imaging device according to claim 48, wherein the display control means enlarges and displays an image selected from the plurality of displayed images on the display means.

51. The device for controlling an imaging device according to claim 47, being provided in one of the plurality of imaging devices.

52. The device for controlling an imaging device according to claim 48, being provided in one of the plurality of imaging devices.

53. A program for causing a computer to execute a method for controlling an imaging device, in which a plurality of imaging devices are associated via a network to be operated to acquire image data, the program causing a computer to execute a procedure for:
displaying an image represented by the image data acquired by a desired imaging device and images represented by the image data acquired by other imaging devices on one display means in different sizes when a plurality of images represented by the plurality of image data acquired by each of the plurality of imaging devices are displayed on the display means.

54. A program for causing a computer to execute a method for controlling an imaging device, in which a plurality of imaging devices are associated via a network to be operated to acquire image data, the program causing a computer to execute a procedure for:
displaying the plurality of images on one display means in different sizes in accordance with distances between the plurality of imaging devices and an object when a plurality of images represented by the plurality of image data acquired by each of the plurality of imaging devices are displayed on the display means.

55. The program according to claim 53, further causing a computer to execute a procedure for enlarging and displaying an image selected from the plurality of displayed images on the display means.

56. The program according to claim 54, further causing a computer to execute a procedure for enlarging and displaying an image selected from the plurality of displayed images on the display means.

57. A method for controlling an imaging device, in which a plurality of imaging devices, comprising clocks and attaching photography date/time data to image data acquired by photographing, are associated via a network to be operated,
wherein times indicated by the clocks of all the imaging devices are synchronized with a predetermined time.

58. The method for controlling an imaging device according to claim 57, wherein the synchronization is performed based on a predetermined operation of one of the plurality of imaging devices.

59. A device for controlling an imaging device, in which a plurality of imaging devices, comprising clocks and attaching photography date/time data to image data acquired by photographing, are associated via a network to be operated, the device comprising:
timer means for synchronizing times indicated by the clocks of all the imaging devices with a predetermined time.

60. The device for controlling an imaging device according to claim 59, wherein the timer means performs the synchronization based on a predetermined operation of one of the plurality of imaging devices.

61. The device for controlling an imaging device according to claim 59, being provided in each of the plurality of imaging devices.

62. A program for causing a computer to execute a method for controlling an imaging device, in which a plurality of imaging devices, comprising clocks and attaching photography date/time data to image data acquired by photographing, are associated via a network to be operated, the program causing a computer to execute a procedure for:
synchronizing times indicated by the clocks of all the imaging devices with a predetermined time.

63. The program according to claim 62, wherein the synchronization is performed based on a predetermined operation of one of the plurality of imaging devices in the synchronization procedure.
